(19) United States
(12) Patent Application Publication
(10) Pub. No.: US 2016/0193932 A1
(43) Pub. Date: Jul. 7, 2016

(54) ELECTRICAL VEHICLE CHARGING DEVICES, SYSTEMS, AND METHODS

(71) Applicant: Pedram Vaghefinazari, Long Beach, CA (US)

(72) Inventor: Pedram Vaghefinazari, Long Beach, CA (US)

(21) Appl. No.: 14/880,724

(22) Filed: Oct. 12, 2015

Related U.S. Application Data
(60) Provisional application No. 62/099,548, filed on Jan. 4, 2015.

(51) Int. Cl. B60L 11/18; H02J 7/00

(52) U.S. Cl. CPC B60L 11/1818; H02J 7/0021; B60L 11/1848; H02J 7/0026; H02J 2007/005

(57) ABSTRACT

A charging station expander (expander) for receiving electrical power from an existing charging station and distributing the electrical power received to at least one PEV is described. The expander increases usability of the existing charging station by permitting the existing charging station to be effectively coupled to two or more PEVs for charging according to methods described herein. The expander may comprise a female port, a switch relay, power distribution cables, a controller, and a housing. The housing may house the switch relay, the controller, portions of the female port, and portions of the power distribution cables. The female port removably couples with a male connector of the existing charging station. The power distribution cables removably couple with the two or more PEVs. The controller controls both an order of how the two or more PEVs may be charged and how a given PEV presently receiving charging may be charged.

### PRIORITY NOTICE

The present application claims priority under 35 U.S.C. §119(e) to U.S. Provisional Patent Application Ser. No. 62/099,548 filed on Jan. 4, 2015, the disclosure of which is incorporated herein by reference in its entirety.

### TECHNICAL FIELD OF THE INVENTION

The present invention relates to plug-in electrical vehicle (PEV) charging devices, apparatus, systems and methods.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Presently (circa 2015) plugin electric vehicles (PEVs) with rechargeable batteries have become extremely popular and prevalent in modern countries, such as, but not limited to, the United States. And that trend only looks to continue and increase for the foreseeable future. However, PEV charging infrastructure has not kept pace with the demand for PEVs. The current state of the PEV charging infrastructure has at least three broad problems: (1) availability of existing PEV charging stations; (2) the cumulative load demands that many PEVs during charging place on the existing power distribution grids that may cause electrical power supply problems and/or shortages (e.g., blackouts); and (3) associated with the load demand problem, is that with increasing load comes increasing cost to the provider who may be providing a plurality of PEV charging stations for consumer use.

With respect to this first broad problem, presently, substantially all parking spots have no associated PEV charging station, whether private or public. Additionally, currently in terms of hardware, the state of the deployed art is: where a parking spot does have an associated PEV charging station, that the configuration is one PEV charging station per one parking spot. See e.g., FIG. 1. FIG. 1 may depict prior art showing existing typical 1:1 correspondence configuration between a single PEV parked in a single parking spot with a single existing PEV charging station 9010. Thus not only are more PEV charging stations needed, but also the existing PEV charging stations 9010 are inadequate because they can only service one PEV at one parking spot and a vast majority of parking spots do not have even an existing PEV charging station. It is obviously not economically feasible nor desirable to retrofit substantially all parking spots with one PEV charging station. However, in the short term, it would be desirable to retrofit all existing PEV charging stations 9010 such that they may be made to service a plurality of PEVs parked at a plurality of parking spots in proximity to the single retrofitted PEV charging station. And it would be desirable that installs of new PEV charging stations would include functionality to service a plurality of PEVs parked at a plurality of parking spots within proximity to the single new PEV charging station.

With respect to the second problem, scheduling PEV charging during off-peak hours and/or when there may be less or minimal loads upon a given power source may be desirable.

With respect to the third broad problem, besides the high cost of PEV charging stations in terms of purchasing and installation, when a plurality of PEV charging stations draw electrical power from a power source simultaneously, this plurality of PEV charging stations can cause the cost of electrical power to increase, often significantly, for a provider who may be providing the plurality of PEV charging stations. Regardless of whether such increase cost in electrical power is passed on to the consumer or the providers carries the burden, or some combination thereof, it would be desirable to smartly and efficiently schedule charging to minimize increase the electrical power cost.

To help better understand the cost of electricity to an electrical consumer, such as a provider of PEV charging stations, consider how Southern California Edison (SCE) presently bills for electrical power consumption. SCE presently utilizes a tiered system that features different per-kilowatt-hour electricity charge rates for different tiers that usage occurs within. During each billing period, an account holder's energy (electricity) consumption starts in Tier 1 (the lowest tier), where the price per kilowatt hour (kWh) is the lowest. Each tier has a certain amount (range) of energy allocated to it. Once the energy consumption in a billing cycle exceeds a lower tier's upper threshold, the charge rate falls into the next higher tier category with a higher per-kilowatt-hour cost. Moreover, the electricity consumption cost may vary depending on the time of the season and also the time of the day. For example, the electricity cost is typically significantly higher during the on-peak hours of daytime versus off-peak hours, often at nighttime. Although not always, the off-peak hours are typically at night (hours may vary based on location). Therefore it becomes desirable, where possible, to defer consuming the electricity to the off-peak hours to benefit from the lower cost (and hopefully a lower tier).

As a general rule, one way to keep energy costs lower is to limit the energy consumption to the lower tiers and closer to off-peak hours within a billing cycle. Using this general rule, providers of parking spots associated with PEV charging stations can lower the cost of their electricity usage significantly by scheduling some or all of the PEV charging into or close to off-peak hours where the electricity costs are significantly less.

As an example of the first, second, and third problems with the current PEV charging infrastructure, consider PEV charging at a public airport, such as Los Angeles International Airport (LAX). LAX presently provides a limited number of parking spaces that have a single PEV charging station 9010 associated with that parking space. See e.g., FIG. 1. A traveler may plug their PEV into one of these single PEV charging stations 9010 while they are away traveling. Most PEVs presently today need only a few hours (e.g. less than six hours) to fully charge their battery, depending on their current battery capacity, level of emptiness, Charge Level (e.g., Level 1, 2, or 3) of the PEV charging station, and other factors. But, since the traveler normally travels for more than this block of six hours, their PEV is left in the designated PEV charging parking spot and attached to the single PEV charging station 9010 for much longer than the amount of time needed for charging their PEV. This is clearly inefficient.

Taking a Chevy Volt as an PEV example, it may take a Chevy Volt about 4 hours to fully charge from a completely depleted battery on a Level 2 (today's most common) PEV charging station 9010. If one assumes that the traveler of a Chevy Volt plugs in their PEV to charge in a PEV parking spot at LAX and goes on a 2-night (48-hour) trip, this PEV is fully charged after the first four hours of being plugged in. However since this PEV cannot be moved until the traveler returns from the trip, no other traveler with PEVs may use that specific single PEV charging station 9010.

There is a need in the art for: (1) an intermediary device that may be used to retrofit existing PEV charging stations 9010 so that the existing PEV charging stations 9010 may be made to service a plurality of PEVs parked at a plurality of parking spots in proximity to the single retrofitted PEV charging station; (2) new PEV charging stations that may be made to service a plurality of EVs parked at a plurality of parking spots in proximity to this new PEV charging station; and (3) having such intermediary devices and the new PEV charging stations comprising controllers that may implement methods that may be one or more of: be convenient for users, practical for users, minimize electrical power consumption cost for users, maximize profits for operators of charging stations, or minimize load demand upon power sources.

It is to these ends that the present invention has been developed.

### BRIEF SUMMARY OF THE INVENTION

To minimize the limitations in the prior art, and to minimize other limitations that will be apparent upon reading and understanding the present specification, some embodiments of the present invention describe a charging station expander for receiving electrical power from an existing charging station and distributing the electrical power received to two or more plug-in electric vehicles (PEVs). Such charging station expanders may increase usability of the existing charging station by permitting the existing stating station to be effectively coupled to two or more PEVs for charging according to various methods described below. That is, such charging station expanders may be used to retrofit existing charging stations. The charging station expander may obtain electrical power necessary to charge PEVs from the existing charging station. The charging station expander may comprise a female port, a switch relay, two or more power distribution cables, a controller and a housing. The housing may house the switch relay, the controller, portions of the female port, and portions of the two or more power distribution cables. The female port may removably couple with a male connector of the existing charging station and thus obtain electrical power from the existing charging station. That is, the male connector of the existing charging station would otherwise have been plugged into a single PEV, but here, is now plugged into the charging station expander. The two or more power distribution cables may removably couple with the two or more PEVs. The controller may control both an order of how the two or more PEVs may be charged (i.e. determining an order of priority for connected PEVs to be charged) and how a given PEV presently receiving charging may be charged.

In addition, a charging station may be described, wherein the charging station may be a synergistic combination of the charging station expander and the existing charging station. So while the charging station expander may be used to retrofit existing charging stations, the charging station may be used in new installs scenarios, e.g., a new parking lot or parking structure being built. In addition, systems and methods for charging two or more PEVs are described.

It is an objective of the present invention to provide a device, a charging station expander, that may increase the usability of existing charging stations such that these existing charging stations may be retrofitted to provide charging services to two or more PEVs that may be removably coupled to the device.

It is another objective of the present invention to provide another device, a charging station, that may be used where one might otherwise install a preexisting charging station that may only couple with one PEV at a time, wherein this other device may instead permit two or more PEVs to be removably coupled to the charging station.

It is yet another objective of the present invention to provide a variety of intelligent and/or flexible means for determining an order of charging PEVs that may be one or more of convenient for users, practical for users, minimize electrical power consumption cost for users, maximize profits for providers of chargers, or minimize load demand upon power sources.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 may depict prior art showing existing typical 1:1 correspondence configuration between a single plug-in electric vehicle (PEV) parked in a single parking spot with a single existing charging station.

FIG. 2A may depict a block diagram showing an exemplary embodiment of a single charging station expander in use removably connected simultaneously to a plurality of PEVs and in so doing may then expand an existing charging station's 1:1 configuration.

FIG. 2B may depict a block diagram of the charging station expander of FIG. 2A, but shown in more detail.

FIG. 2C may depict a block diagram of further details of a controller of the charging station expander of FIG. 2A.

FIG. 2D may depict an exterior perspective view of the charging station expander of FIG. 2A.

FIG. 2E may depict a front view of the charging station expander depicted in FIG. 2D.

FIG. 2F may depict a back view of the charging station expander depicted in FIG. 2D, showing a female port.

FIG. 2G may depict a top view of the charging station expander depicted in FIG. 2D.

FIG. 2H may depict a bottom view of the charging station expander depicted in FIG. 2D.

FIG. 2I may depict a side view of the charging station expander depicted in FIG. 2D.

FIG. 2J may depict the charging station expander depicted in FIG. 2D comprising one or more mounting structures.

FIG. 2K may depict the charging station expander depicted in FIG. 2D comprising safety structure that may protect the charging station expander from impacts and/or tampering.

FIG. 3A may depict a block diagram showing an exemplary embodiment of a single charging station in use removably connected simultaneously to a plurality of PEVs.

FIG. 3B may depict a block diagram of the charging station expander of FIG. 3A, but shown in more detail.

FIG. 3C may depict an exterior perspective view of the charging station of FIG. 3A.

FIG. 3D may depict a back view of the charging station expander depicted in FIG. 3C, showing a hard wired connection to the grid or to a power source.

FIG. 4A may depict a block diagram of an exemplary system utilizing one or more charging station expanders in conjunction with one or more servers.

FIG. 4B may depict an environment in which charging station expanders may be used; and/or FIG. 4B may depict a block diagram of an exemplary system utilizing one or more charging station expanders in conjunction with one or more servers.

FIG. 5A may depict a block diagram of an exemplary system utilizing one or more charging stations in conjunction with one or more servers.

FIG. 5B may depict an environment in which charging stations may be used; and/or FIG. 5B may depict a block diagram of an exemplary system utilizing one or more charging stations in conjunction with one or more servers.

FIG. 6A may depict a flow diagram showing steps of an exemplary method of distributing electrical power to two or more PEVs utilizing a charging station expander or a charging station.

FIG. 6B may depict a flow diagram showing steps of an exemplary method of distributing electrical power to two or more PEVs utilizing a charging station expander.

FIG. 6C may depict a flow diagram showing steps of an exemplary method of distributing electrical power to two or more PEVs utilizing a charging station expander.

FIG. 6D may depict a flow diagram showing alternative steps of an exemplary method of distributing electrical power to two or more PEVs utilizing a charging station expander.

FIG. 6E may depict a flow diagram depicting further detailed steps for determining a number of PEVs that may be ready for charging.

FIG. 6F may depict a flow diagram depicting further detailed steps for determining an order of charging the PEVs.

FIG. 6G may depict an organizational diagram showing various options for an order of power distribution algorithm, wherein such selected or predetermined options may determine the order of charging the PEVs.

FIG. 6H may depict a continued organizational diagram from FIG. 6G.

FIG. 6I may depict a flow diagram depicting further detailed steps for how the electrical power may be distributed to the PEVs.

FIG. 7 may depict a logic flow diagram showing an embodiment of utilizing a predetermined state of charge (SOC) reached as a benchmark for terminating electrical power transmission to one PEV and switching to power (charge) a next PEV up in a queue.

FIG. 8 may depict a logic flow diagram showing an embodiment of utilizing a selected stop time reached as a benchmark for terminating electrical power transmission to one PEV and switching to power (charge) a next PEV up in the queue.

FIG. 9 may depict a logic flow diagram for determining an order of charging based on a first to connect first to charge basis of assigning charging priority.

FIG. 10A may depict a method for determining at least one optimal charging schedule for one or more PEVs.

FIG. 10B may depict a priority relationship between some PEV assignments and may also depict some priority relationships between prioritized parameters.

### REFERENCE NUMERAL SCHEDULE

200 charging station expander 200
202 female port 202
210 switch relay 210
212 two or more switches 212
214 two or more power distribution cables 214
216 final male connector 216
220 controller 220
222 memory 222
224 processor 224
226 network adapter 226
236 integral display 236
250 integral input device 250
252 safety problem detector 252
270 housing 270
272 exterior 272
273 door 273
274 one or more mounting structures 274
275 region for displaying 275
276 safety structure 276
300 charging station 300
302 connection 302
400 system 400
410 server 410
420 network 420
450 system 450
500 system 500
550 system 550
600 method 600
600a method 600a
600b method 600b
600c method 600c
602 determining if Charging Station Expander 200 or Charging Station 300 is receiving electrical power 602
602a determining if Charging Station Expander 200 is receiving electrical power 602a
604 determining number of PEVs ready for charging 604
606 determining order of charging PEVs 606
608 distributing power to PEVs 608
610 send communication pilot signal 610
612 receive male connector to female port 612
614 verify proper connection between female port and male connector 614
616 determine number of final male connectors removably coupled to PEV ports 616
618 determine number of PEVs connected to Station 200/300 ready for charging 618
618a receive appropriate pilot signal from PEV 618a
620 receive valid payment selection 620
622 predetermined order of power distribution algorithm 622
624 user selected order of power distribution algorithm 624
626 order of power distribution algorithm 626
628 priority by first in time to connect 628
630 priority by lowest SOC 630
632 priority by highest SOC 632
634 by receiving selected time slot 634
636 by receiving selected start and stop time 636
638 priority by expected departure time 638
640 priority by received smallest desired SOC 640
642 priority by received highest desired SOC 642
644 priority by received smallest desired SOC or by expected departure time 644
646 by higher amount paid 646
648 parallel charging by load, available supply, and circuit constraints 648
608 distributing power to PEVs 608
650 PEV distribution algorithm 650
652 predetermined SOC reached 652
654 selected stop time reached 654
656 selected departure time reached 656
658 conclusion of selected time slot 658
660 payment exhausted 660
1000 method for determining at least one optimal charging schedule for one or more plug-in PEVs 1000 (method 1000)
1002 receive PEV assignments 1002
1004 receive prioritized parameters 1004
1006 determine at least one time slot for charging 1006
1011 first user with different numeral rank 1011
1013 second user with different numerical rank 1013
1021 at least one work-commuter-need 1021
1023 at least one non-commuting-need 1023
1025 load on supply constraints 1025
9010 existing charging station 9010
9012 cable 9012
9014 male connector 9014
9020 power source 9020
9030 plug-in electrical vehicles 9030 (PEV 9030)
9032 port 9032
9040 one or more mobile devices 9040
9050 one or more users 9050

### DETAILED DESCRIPTION OF THE INVENTION

A charging station expander for receiving electrical power from an existing charging station and distributing the electrical power received to two or more plug-in electric vehicles (PEVs) is described. The charging station expander increases usability of the existing charging station by permitting the existing stating station to be effectively coupled to two or more PEVs for charging and then charged according to various methods described below. That is, such charging station expanders may be used to retrofit existing charging stations. The charging station expander may obtain electrical power necessary to charge PEVs from the existing charging station. The charging station expander may comprise a female port, a switch relay, two or more power distribution cables, a controller and a housing. The housing may house the switch relay, the controller, portions of the female port, and portions of the two or more power distribution cables. The female port may removably couple with a male connector of the existing charging station and thus obtain electrical power from the existing charging station. That is, the male connector of the existing charging station would otherwise have been plugged into a single PEV, but here, is now plugged into the charging station expander. The two or more power distribution cables may removably couple with the two or more PEVs. The controller may control both an order of how the two or more PEVs may be charged (i.e. determining an order of priority for connected PEVs to be charged) and how a given PEV presently receiving charging may be charged.

In addition, a charging station may be described, wherein the charging station may be a synergistic combination of the charging station expander and the existing charging station. So while the charging station expander may be used to retrofit existing charging stations, the charging station may used in new installs scenarios, e.g., a new parking lot or a new parking structure being built. In addition, systems and methods for charging two or more PEVs are described.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

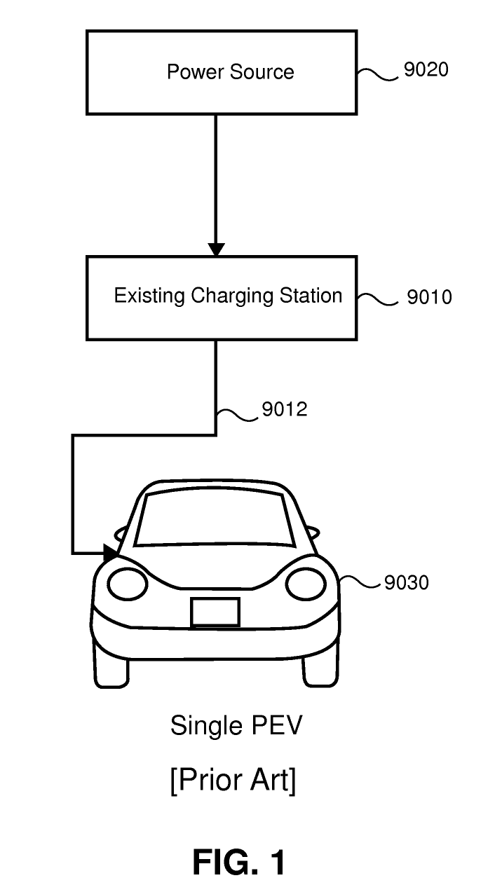

FIG. 1 may depict prior art showing existing typical 1:1 correspondence configuration between a single plug-in electric vehicle (PEV) 9030 parked in a single parking spot with a single existing charging station 9010. A discussion of FIG. 1 was introduced above in the BACKGROUND OF THE INVENTION section.

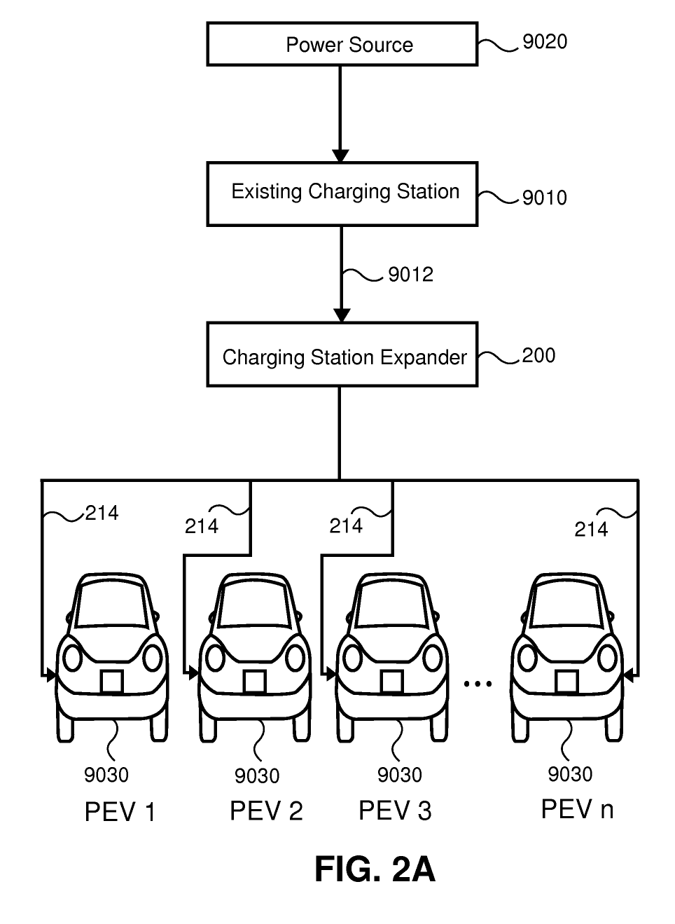

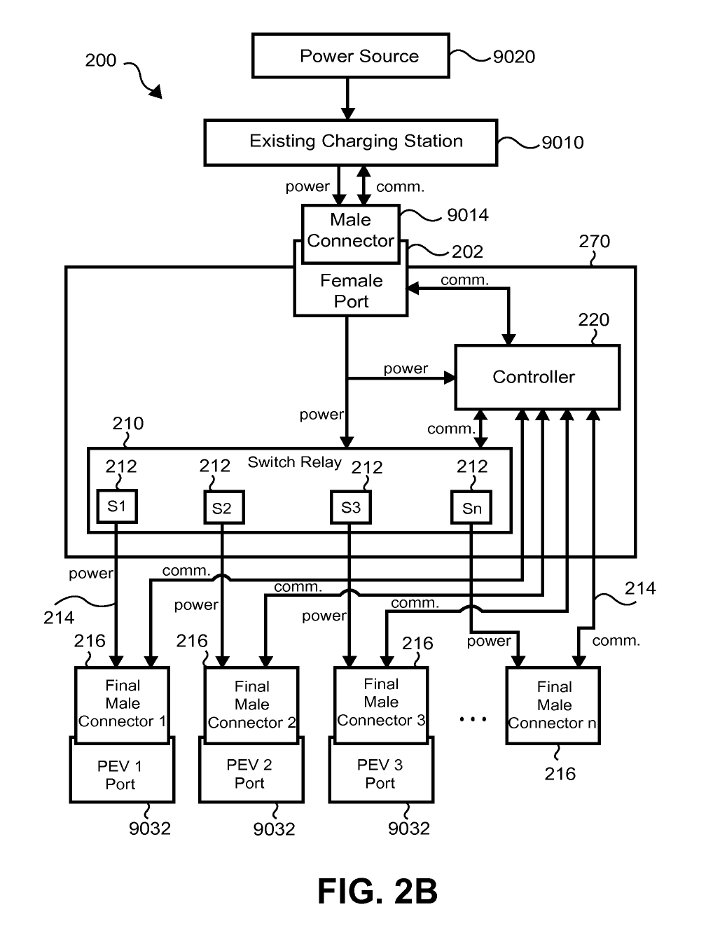

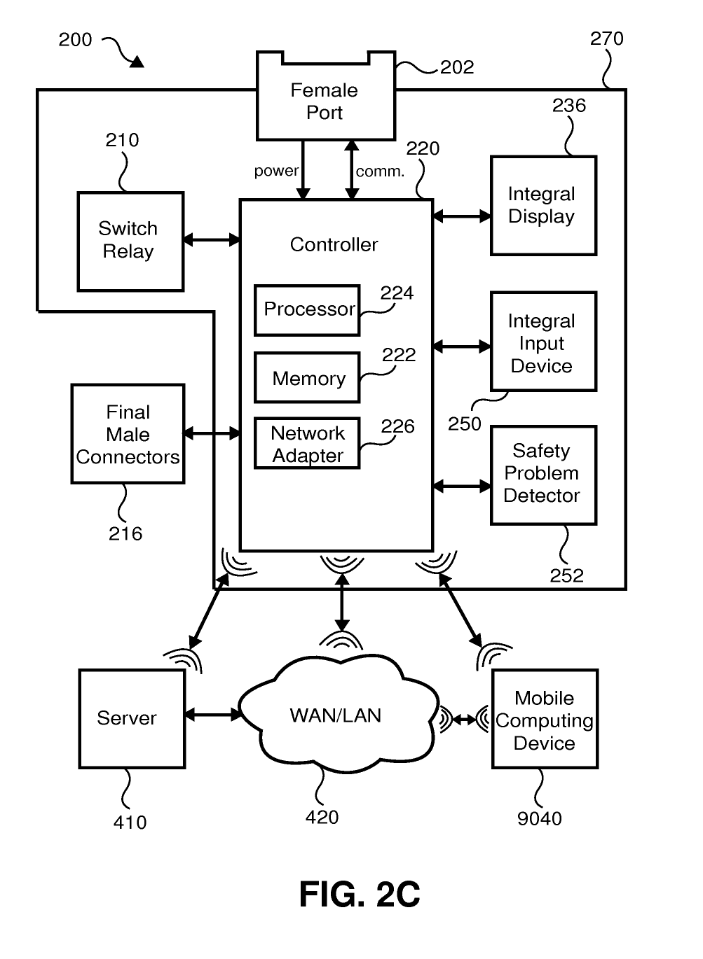

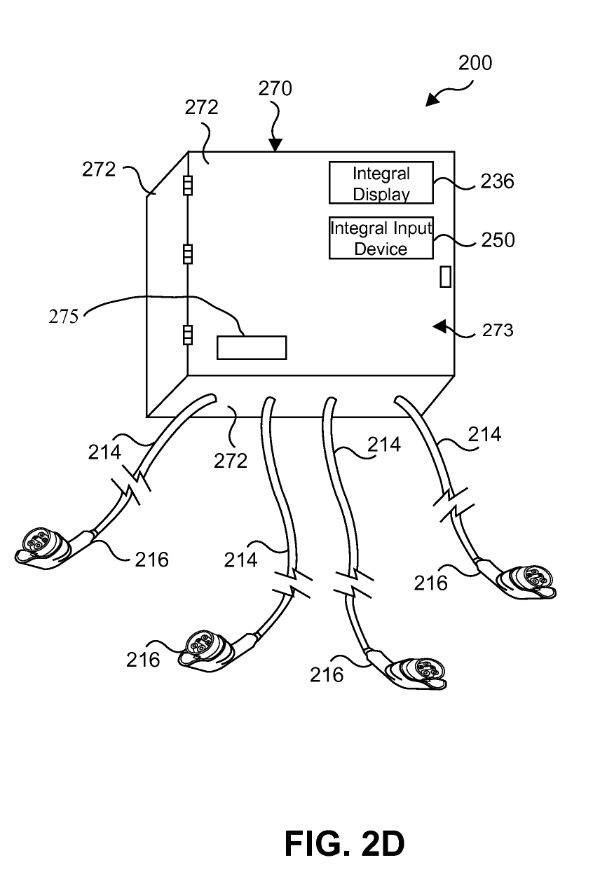

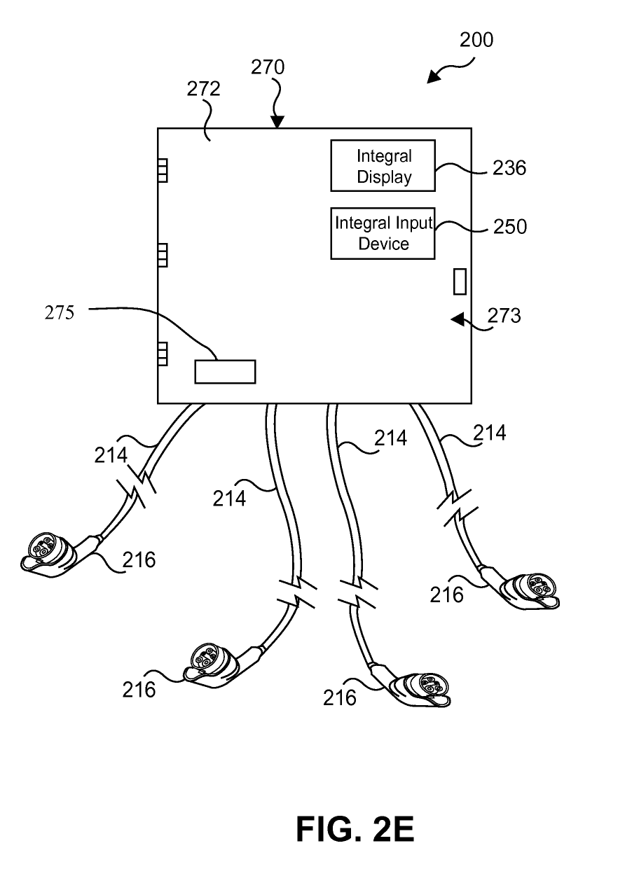

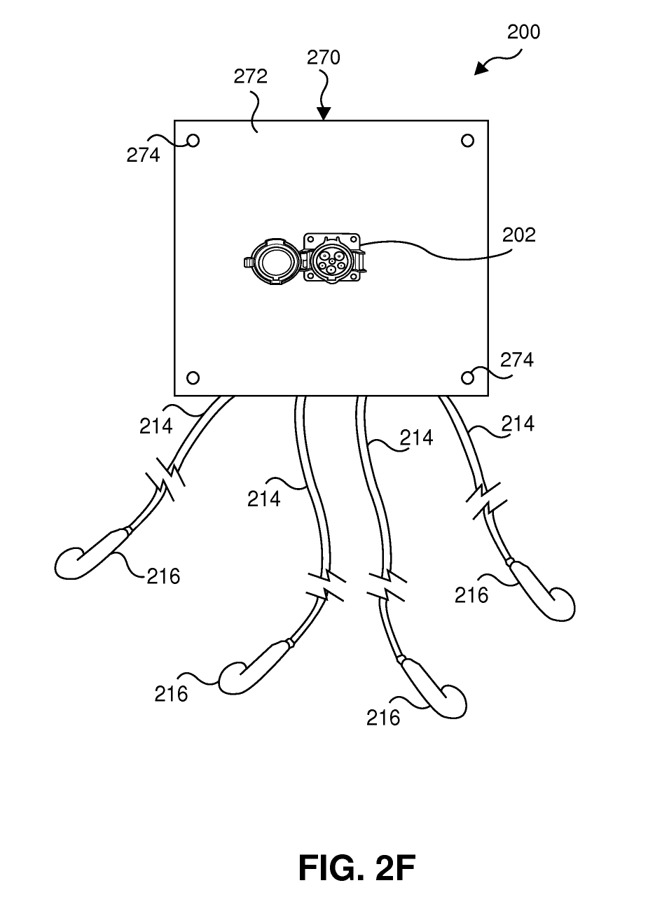

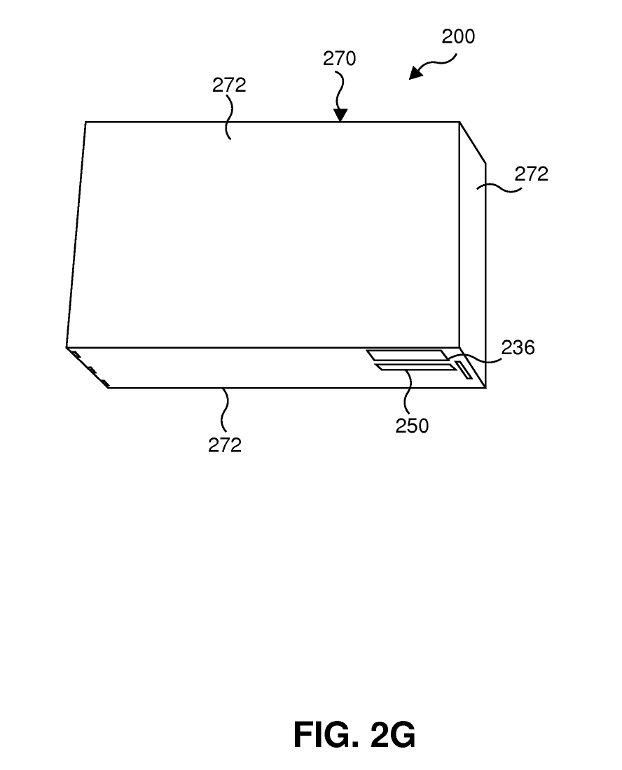

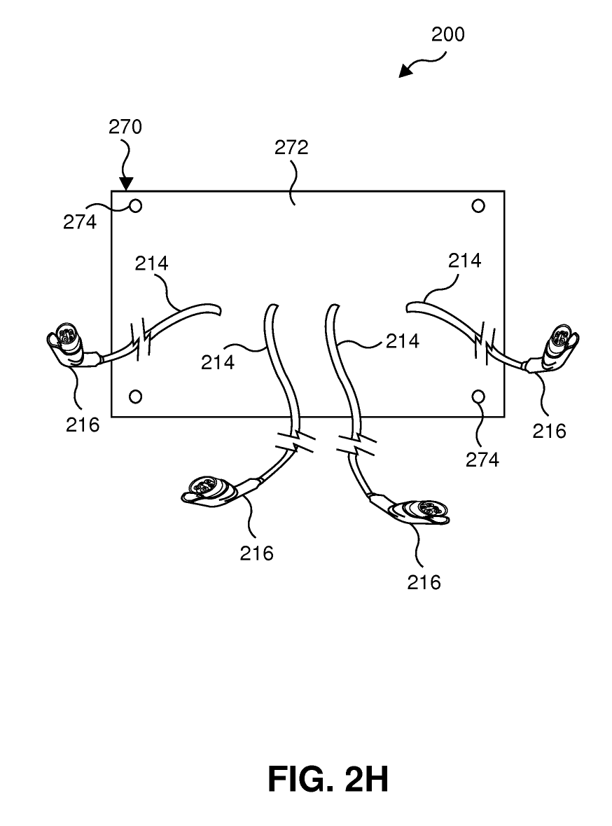

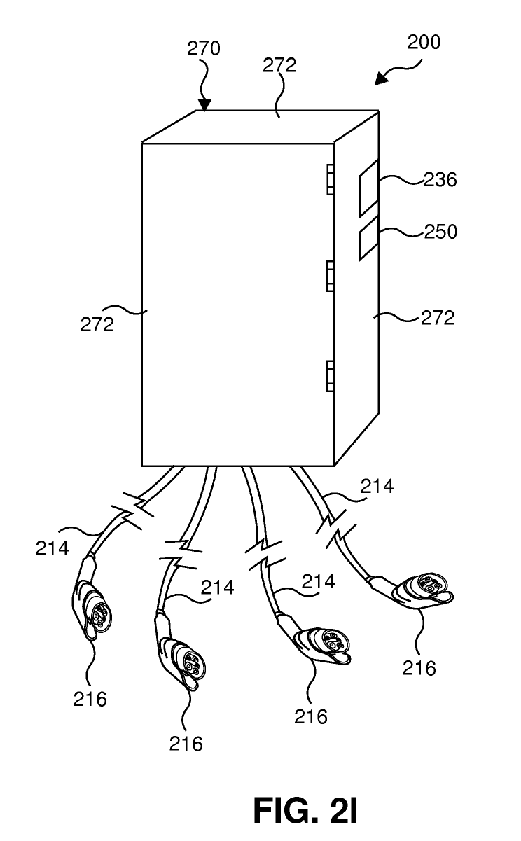

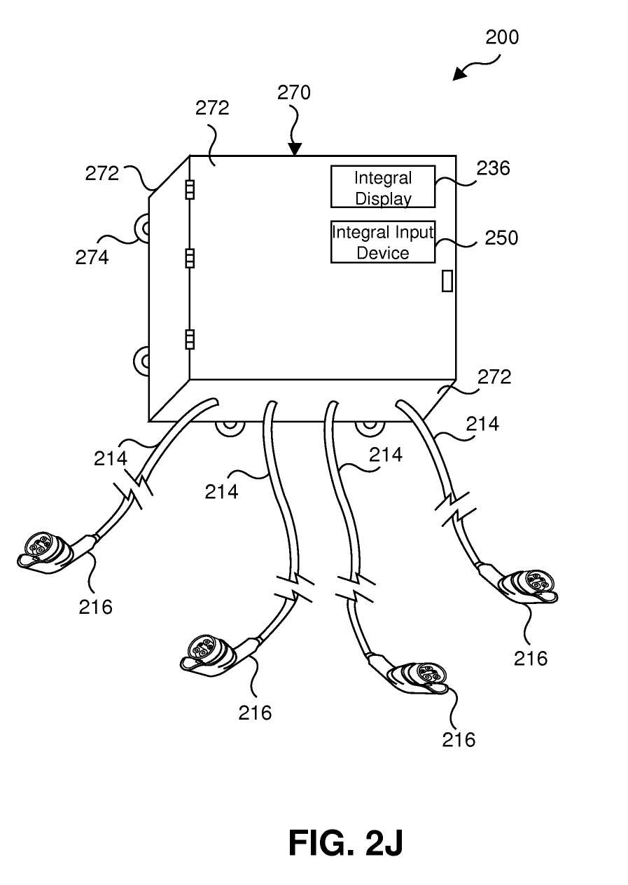

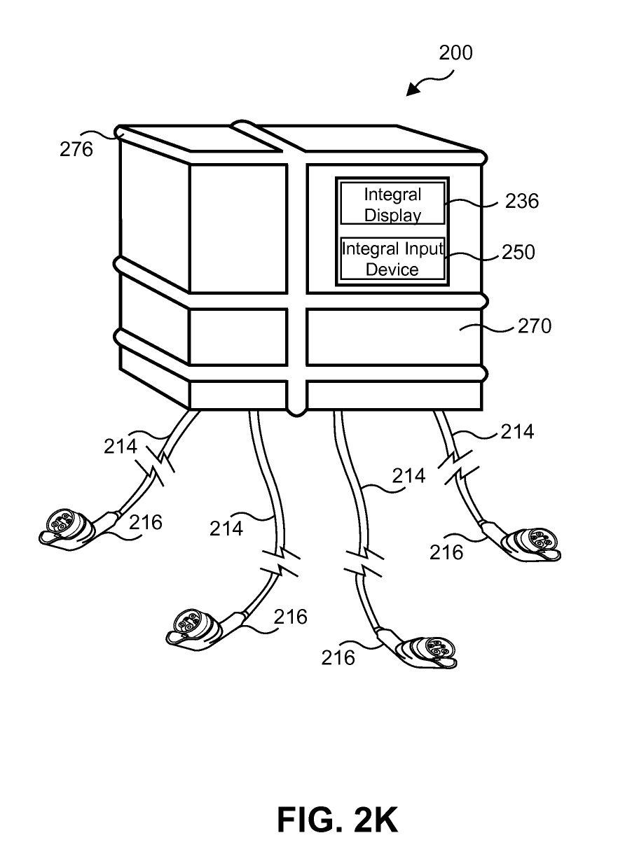

A FIG. 2 series of figures may comprise FIG. 2A through FIG. 2K. These FIG. 2 series figures may focus on a charging station expander 200 and on various embodiments of such a charging station expander 200. In some embodiments, charging station expander 200 may receive electrical power from an existing charging station 9010 and then distribute that received electrical power to two or more plug-in electrical vehicles 9030 (PEVs 9030). Or more technically, charging station expander 200 may receive electrical power from an existing charging station 9010 and then distribute at least some of that received electrical power to two or more PEVs 9030, since some of the electrical power received may be used to operate controller 220 (see e.g., FIG. 2B for controller 220) and/or from inherent resistance losses in circuits and wiring.

FIG. 2A may depict a block diagram showing an exemplary embodiment of a single charging station expander 200 in use removably connected (coupled) simultaneously to a plurality of PEVs 9030 (e.g., two or more PEVs 9030) and in so doing may then expand an existing charging station 9010's 1:1 configuration into a 1:n configuration. In some embodiments, charging station expander 200 may be disposed between existing charging station 9010 and two or more PEVs 9030. For example, compare FIG. 2A with FIG. 1. FIG. 1 may depict the typical 1:1 configuration of a single existing charging station 9010 removably connected to a single PEV 9030. Whereas, in FIG. 2A, the single existing charging station 9010's cable 9012 may be removably connected to a single charging station expander 200; and this single charging station expander 200 may comprise two or more power distribution cables 214; wherein each two or more power distribution cables 214 may be removably connected to a given PEV 9030; which may thus greatly expand a usefulness of the single existing charging station 9010. Thus a given charging station expander 200 may be used to retrofit the single existing charging station 9010 and possibly without any modification to the single existing charging station 9010.

Note, in some embodiments, each two or more power distribution cables 214 may be substantially similar, structurally and/or functionally with cable 9012 of a given existing charging station 9010. For example, both two or more power distribution cables 214 and cable 9012 may each provide for both electrical power transmission and for communication of various signals, such as pilot signals, and/or other communication signals conveying various information, such as one or more of: user information, PEV information, desired charging algorithm (e.g., order of power distribution algorithm 626), selected charging algorithm from a list of available charging algorithms (e.g., order of power distribution algorithm 626), selected payment method, and/or the like.

In FIG. 2A, a quantity of PEVs 9030 that may be removably connected to charging station expander 200 is n, which may also be a quantity for the two or more power distribution cables 214. n in any given deployment (installation) of charging station expander 200 is a finite whole number of at least two. A maximum for n may be determined by how many parking spaces are immediately proximate to charging station expander 200, including either or both of below and above grade where charging station expander 200 may be installed at; and on how long each two or more power distribution cables 214 may be. For example, and without limiting the scope of the present invention, n may be selected from 2, 3, 4, 5, 6, 7, 8, 9, 10, 11, 12, 13, 14, or 15. For example, and without limiting the scope of the present invention, n may be 2, 4, or 6 in most deployments of charging station expander 200. For convenience and as an example and without limiting the scope of the present invention, the figures referenced herein may be shown with a value of 4 for n.

FIG. 2B may depict a block diagram of the charging station expander 200 of FIG. 2A, but shown in more detail with respect to the various components and/or elements of charging station 200.

In some embodiments, charging station expander 200 may comprise a female port 202, a switch relay 210, two or more distribution cables 214, a controller 220, and a housing 270. See e.g., FIG. 2B. In some exemplary embodiments, charging station expander 200 may not comprise existing charging station 9010.

In some embodiments female port 202 may removably receive a male connector 9014 of cable 9012 of existing charging station 9010. That is, in some embodiments, female port 202 may removably couple (connect) with male connector 9014. And in so doing, female port 202 may be a first location of charging station expander 200 wherein the electrical power from existing charging station 9010 is received. In some embodiments, female port 202 may receive the electrical power (or at least some of the electrical power) from male connector 9014.

Note, in some embodiments, this coupling (connection) between female port 202 and male connector 9014 may be removable; while in other embodiments this coupling (connection) may be intended to be permanent, aside from making repairs and/or maintenance.

In some embodiments, switch relay 210 may comprise two or more switches 212. In some embodiments, switch relay 210 may be in electrical communication with female port 202 such that at least some of the electrical power from female port 202 may be received at switch relay 210. In some embodiments, this electrical communication may be accomplished by one or more wires capable of transmitting electrical current that may be disposed between female port 202 and switch relay 210. See e.g., FIG. 2B. In some embodiments, each switch 212 selected from two or more switches 212 may comprise one of two mutually exclusive operational states: engaged or non-engaged. In some embodiments, in the engaged operational state a given switch 212 may allow electrical flow. In some embodiments, in the non-engaged operational state the given switch 212 may not allow electrical flow.

In some embodiments, two or more switches 212 may be arranged in a parallel configuration. In some embodiments, two or more switches 212 may be arranged in a parallel circuit arrangement. See e.g., FIG. 2B. In some embodiments, controller 220 may operate switch relay 210 in a serial fashion (e.g., one use at a time) or in a parallel fashion (e.g., multiple simultaneous use) or a combination thereof. When controller 220 may be operating switch relay 210 in a serial fashion, only one switch 212 may be in the engaged operational state; while the remaining switches 212 may be in the non-engaged operational state. Whereas, if controller 220 may be operating switch relay 210 in a parallel fashion, two or more switches 212 may be simultaneously in the engaged operational state.

In some embodiments, two or more switches 212 may comprise a number of switches 212. In some embodiments, this number may be a finite whole number of at least two. In some embodiments, the number of switches 212 may correspond to the quantity of two or more distribution cables 214. In some embodiments, the number of switches 212 corresponds to the quantity of two or more distribution cables 214 in a 1:1 correspondence. In some embodiments, the quantity of two or more distribution cables 214 may correspond to the number of switches 212. For example, and without limiting the scope of the present invention, this number of switches 212 may be selected from 2, 3, 4, 5, 6, 7, 8, 9, 10, 11, 12, 13, 14, or 15. For example, and without limiting the scope of the present invention, this number of switches 212 may be 2, 4, or 6 in most deployments of charging station expander 200.

In some embodiments, each power distribution cable 214 selected from the two or more power distribution cables 214 may originate from each switch 212 selected from two or more switches 212. In some embodiments, each power distribution cable 214 selected from two or more power distribution cables 214 may terminate in a final male connector 216. In some embodiments, each final male connector 216 may removably connect (couple) to a port 9032 of each PEV 9030 selected from the two or more PEVs 9030. See e.g., FIG. 2B. In some embodiments, each power distribution cable 214 may receive at least a portion of the at least some of the electrical power from the switch 212 in which the power distribution cable 214 may be connected to that may be engaged.

In some embodiments, each distribution cable 214 selected from two or more distribution cables 214 may comprise wiring for electrical power transfer and separate wiring for communications between controller 220 and each PEV 9030 selected from two or more PEVs 9030 that each final male connector 216 may be removably connected to. See e.g., FIG. 2B. In FIG. 2B, arrows disposed between a given switch 212 and a given final male connector 216 that include the word, “power” may denote the aspect of power distribution cable 214 used for electrical power transmission. In FIG. 2B, arrows disposed between controller 220 and a given final male connector 216 that include the abbreviation, “comm.” for “communication” may denote the aspect of power distribution cable 214 used for communication. Both the power transmission aspect and the communication aspect may be bundled together, e.g., separate wires within a common sheath, in each power distribution cable 214 for a length of power distribution cable 214 that may be disposed between housing 270 and final male connector 216. See e.g., FIG. 2D where the power distribution cables 214 shown may comprise both the power transmission aspect and the communication aspect.

Continuing discussing FIG. 2B, in some embodiments, controller 220 may control the flow of electrical power distribution permitted through two or more distribution cables 214. In some embodiments, controller 220 may control switch relay 210 and/or may control each individual switch 212 selected from two or more switches 212. In some embodiments, controller 220 may be in electrical communication with switch relay 210 and/or with each individual switch 212 of two or more switches 212. In some embodiments, such electrical communication may be via electrical wiring. In some embodiments, controller 220 may comprise memory 222 and a processor 224 (e.g., at least one processor). See e.g., FIG. 2C. In some embodiments, memory 222 and the processor 224 may be in electrical communication with each other. In some embodiments, such electrical communication may be via electrical and/or optical wiring or via one or more integrated (printed) circuit boards and/or chips. In some embodiments, memory 222 may non-transitorily store software (e.g., code), wherein processor 224 may execute the software to control switch relay 210 by at least engaging and/or disengaging switches 212 selected from the two or more switches 212.

Continuing discussing FIG. 2B, in some embodiments, housing 270 may house switch relay 210 and controller 220. In some embodiments, female port 202 may be located on an exterior 272 of housing 270. In some embodiments, at least a portion of female port 202 may be located on exterior 272. See e.g., FIG. 2F. In some embodiments, female port 202 may be accessible from exterior 272. In some embodiments, at least a portion of female port 202 may be accessible from exterior 272. In some embodiments, at least some portion of two or more distribution cables 214 may emerge from housing 270. See e.g., FIG. 2H. In some embodiments, final male connectors 216 may be located externally of housing 270. See e.g., FIG. 2D.

In some embodiments, charging station expander 200 may comprise at least two circuits, a first circuit and a second circuit. The first circuit for facilitating electrical power transmission from a source (e.g., existing charging station 9010) and ultimately to two or more PEVs 9030. Portions of: female port 202, switch relay 210, switches 212, two or more distribution cables 214, and final male connectors 216 may be components of the first circuit. And the second circuit for controlling the first circuit, wherein the second circuit may be low voltage with various communication, and/or various input and various output signals routing along the second circuit. In some embodiments, each circuit may comprise one or more of: surge protectors, power conditioners, rectifiers/inverter/converter (e.g., AC to DC converter), or transformers. In some embodiments, charging station expander 200 may not comprise any rectifiers, since such components may be present in existing charging station 9010.

FIG. 2C may depict a block diagram of further details of controller 220 of the charging station expander 200. In some embodiments, controller 220 may receive power (e.g., electrical power) from female port 202 and/or from switch relay 210. In some embodiments, controller 220 may receive power (e.g., electrical power) from one or more of: female port 202, switch relay 210, an independent power source that may be independent of existing charging station 9010, and/or the like. In some embodiments, the independent power source may be a battery. In some embodiments, the independent power source may be a rechargeable battery. In some embodiments, the independent power source may operate as a backup power source for charging station expander 200. In some embodiments, this independent power source may be located within housing 270.

In some embodiments, this power received by controller 220 may be used to operate controller 220. In some embodiments, this power received by controller 220 may be used to operate controller 220 in operation of switch relay 210 from transitioning a given switch 212 from engaged to non-engaged and vice-versa. In some embodiments, this power received by controller 220 may be used to operate controller 220 and to facilitate communications between one or more of: between controller 220 and existing charging station 9010; between controller 220 and switch relay 210; between controller 220 and switches 212; between controller 220 and two or more PEVs 9030 removably coupled to a respective final male connector 216; and/or the like. In some embodiments, communications between controller 220 and switch relay 210, switches 212, final male connector 216, and/or female port 202, may be routed through an internal bus. In some embodiments, controller 220 may comprise this internal bus.

In some embodiments, controller 220 may send a communication pilot signal to female port 202. In such embodiments, female port 202 may further communicate this communication pilot signal to male connector 9014 that may be (removably) coupled (connected) to female port 202. In some embodiments, this communication pilot signal may mimic a pilot signal that may be typically associated as originating from a PEV with a status of connected and ready to receive electrical power, such that existing charging station 9010 may then distribute the electrical power to charging station expander 200.

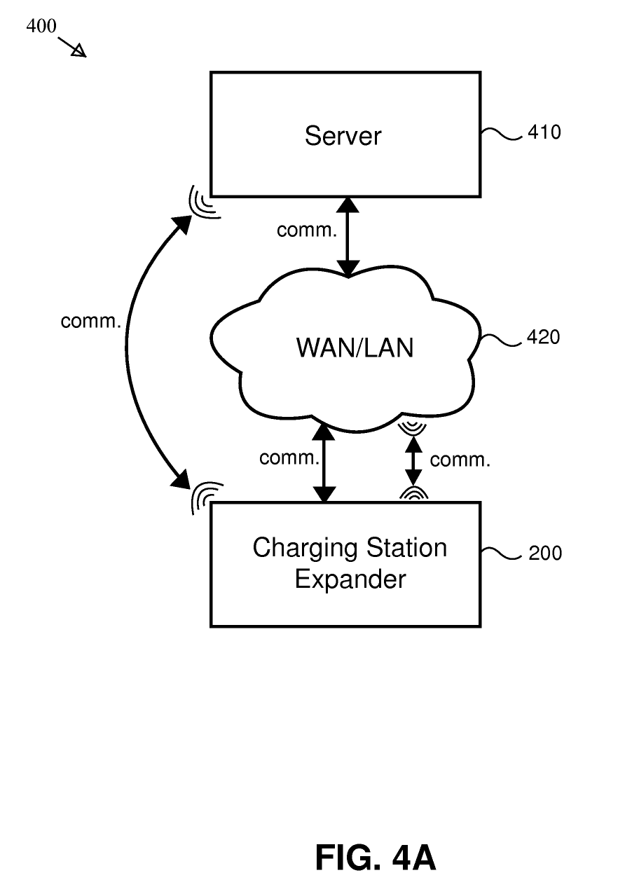

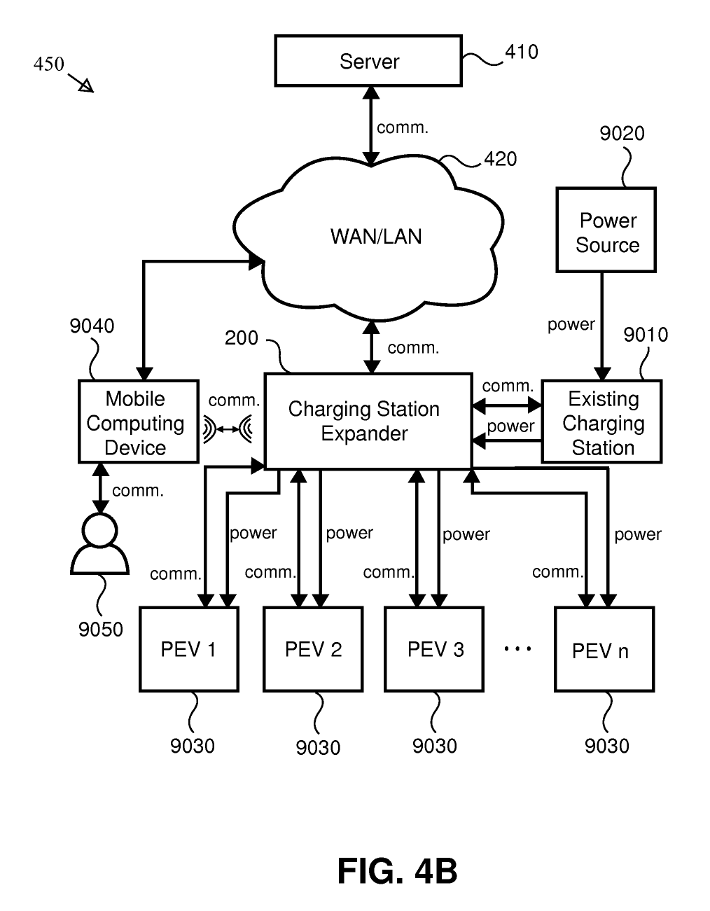

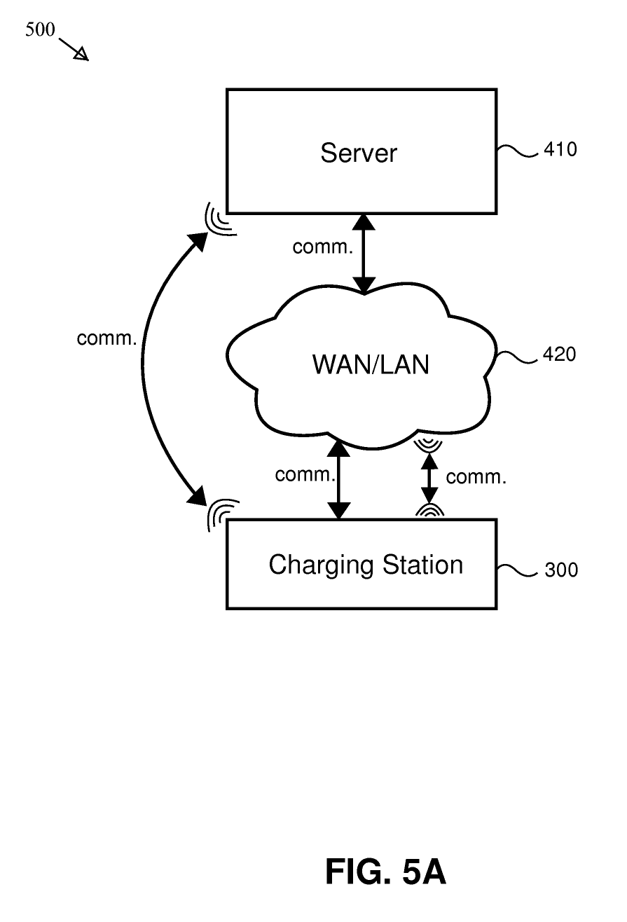

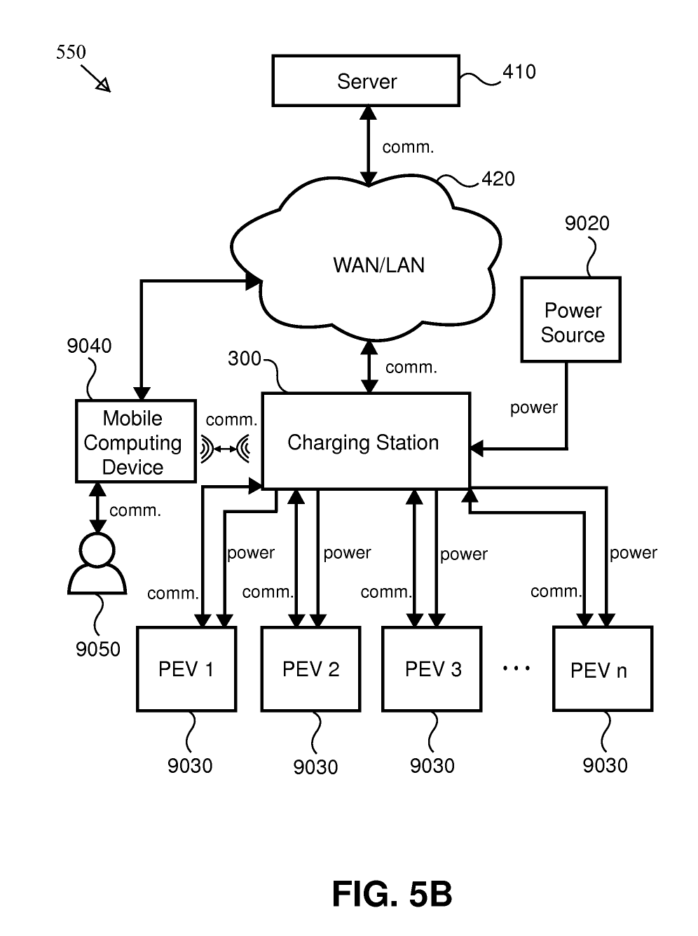

In some embodiments, controller 220 may comprise one or more of the following: a network adapter 226, a modem, a router, and/or the like. In some embodiments, network adapter 226 may comprise one or more of the modem and/or the router. In some embodiments, network adapter 226, the modem, and/or the router may each comprise at least one radio or at least one antenna. In some embodiments, the at least one radio and/or the at least one antenna may be configured to one or more of the following: to receive radio transmissions and/or to broadcast radio transmissions. In some embodiments, one or more of the network adapter 226, the modem, or the router provide wireless communication via a wireless protocol utilizing the at least one radio or the at least one antenna. For example, wireless communications may be indicated in FIG. 2C, FIG. 4A, FIG. 4B, FIG. 5A, and FIG. 5B by two sets of three concentric arcs with a double headed arrow disposed between the two sets of the three concentric arcs.

In some embodiments, the one or more of the network adapter 226, the modem, the router, and/or the like may be in electrical communication with processor 224. In some embodiments, such electrical communication may be via electrical and/or optical wiring or via one or more integrated (printed) circuit boards and/or chips. In some embodiments, the one or more of the network adapter 226, the modem, the router, and/or the like may operate as one or more gateways to facilitate communications with one or more of the following: one or more mobile computing devices 9040, one or more PEVs 9030, more or more remote servers 410, and/or the like. See e.g., FIG. 2C. Note, in some embodiments and/or in some configurations, the one or more mobile computing devices 9040 may be integral and located within a given PEV 9030.

For example, and without limiting the scope of the present invention, communication between the one or more servers 410 and controller 220 may be over a network 420. Network 420 may be one or more of a LAN (local area network), a WAN (wide area network), the Internet, combinations thereof, and/or the like. For example, and without limiting the scope of the present invention, communication between the one or more mobile computing devices 9040 and controller 220 may be over network 420. For example, and without limiting the scope of the present invention, communication between the one or more mobile computing devices 9040 and controller 220 may be via direct wireless communication, and not over network 420. For example, and without limiting the scope of the present invention, communication between a given PEV 9030 and controller 220 may be over network 420. For example, and without limiting the scope of the present invention, communication between a given PEV 9030 and controller 220 may be via direct wireless communication (and/or wired communication), and not over network 420.

One or more users 9050 via the one or more mobile devices 9040 may enter user inputs into the one or more mobile devices 9040. In some embodiments, such user inputs may be received by the one or more of the network adapter 226, the modem, and/or the router. In some embodiments, these received user inputs may then be communicated to processor 224. In some embodiments, processor 224 in response to these received user inputs may generate display outputs that may then be directed from processor 224 to the one or more of the network adapter 226, the modem, and/or the router. Where in some embodiments, the one or more of the network adapter 226, the modem, and/or the router may then transmit the display outputs to the one or more mobile devices 9040, for display on the one or more mobile devices 9040.

In some embodiments, the user inputs that processor 224 may be capable of interpreting may be selected from one or more of the following: user information, PEV information, desired charging algorithm (e.g., order of power distribution algorithm 626), selected charging algorithm from a list of available charging algorithms (e.g., order of power distribution algorithm 626), selected payment method, or the like.

In some embodiments, with respect to any given user 9050, user information may comprise a user-account. In some embodiments, PEV information (specific to a given PEV 9030) may comprise the SOC (state of charge) and/or the vehicle identification (ID). SOC may refer to a battery (or bank of batteries) charge level of a given PEV 9030. SOC may be expressed a percentage of being charged, e.g., 100% may indicate a battery is completely charged, while 0% may indicate a battery is complete depleted.

In some embodiments, controller 220 may comprise an integral display 236. In some embodiments, integral display 236 may optional. In some embodiments, integral display 236 may be located on a portion of the exterior 272 of housing 270. See e.g., FIG. 2D. For example, and without limiting the scope of the present invention, this portion may be a front, a top, a side, a back, or a bottom of exterior 272. Continuing discussing FIG. 2C, in some embodiments, integral display 236 may be in electrical communication with processor 224 (either directly or via bus). In some embodiments, such electrical communication may be via electrical wiring. In some embodiments, integral display 236 may display the display outputs directed from processor 224 to the integral display 236.

In some embodiments, the display outputs may depict one or more of the following: a status of charging station expander 200; a status of each PEV removably connected to charging station expander 200; which PEV 9030 may be currently charging; which PEV 9030 may be next in que to receive distribution of at least some of the electrical power, i.e. to receive charging; when the current PEV 9030 currently receiving charging may be stopped from further charging, and/or the like. In some embodiments, one or more of such display outputs may also be directed from processor 224 to one or more mobile devices 9040, e.g., by utilizing network adapter 226, the modem, and/or the router.

In some embodiments, integral display 236 may comprise one or more of the following: at least one light, a screen, a touch screen, a speaker, a siren, and/or a buzzer. In some embodiments, the at least one light may be one or more light emitting diodes (LEDs). In some embodiments, the screen may a liquid crystal display (LCD) screen, a LED screen, and/or a cathode ray screen.

In some embodiments, controller 220 may comprise an integral input device 250. In some embodiments, integral input device 250 may optional. In some embodiments, integral input device 250 may be located on a portion of exterior 272 of housing 270, in a similar manner as integral display 236 may be located. See e.g., FIG. 2D. Continuing discussing FIG. 2C, in some embodiments, integral input device 250 may be in electrical communication with processor 224 (either directly or via bus). In some embodiments, such electrical communication may be via electrical wiring. In some embodiments, integral input device 250 may receive user 9050 inputs. In some embodiments, integral input device 250 may direct those received user inputs to processor 224 (for interpretation according to the software and/or code non-transitorily stored within memory 222).

In some embodiments, the user inputs that processor 224 may be capable of interpreting may be selected from one or more of the following: user information, PEV vehicle information, desired charging algorithm (e.g., order of power distribution algorithm 626), selected charging algorithm from a list of available charging algorithms (e.g., order of power distribution algorithm 626), selected payment method, and/or the like.

In some embodiments, integral input device 250 may comprise one or more of the following: a microphone, at least one button, at least one switch, at least one lever, at least one dial, at least one slide, a touch screen, a keyboard, a joystick, a mouse, a payment receiving device, and/or the like.

In some embodiments, integral display 236 and integral input device 250 may be the same hardware device. For example, and without limiting the scope of the present invention, integral display 236 and integral input device 250 may be an integrated touch screen configured for both output and input. For example, and without limiting the scope of the present invention, integral display 236 and integral input device 250 may be an integrated touch screen configured for displaying display outputs and for receiving user 9050 inputs.

In some embodiments, the payment receiving device of integral input device 250 may be selected from one or more of the following: a credit card reader, a means for accepting coins, a means for accepting currency bills, a means for returning change, the at least one radio and/or the at least one antenna configured for facilitating payment via a mobile payment system, and/or the like. In some embodiments, one or more of network adapter 226, the modem, and/or the router, via the at least one radio and/or the at least one antenna may facilitate one or more mobile payment systems.

In some embodiments, the at least one radio and/or the at least one antenna may be a component of the network adapter 226, the modem, and/or the router. In some embodiments, the at least one radio may comprise at least one antenna. In some embodiments, the at least one antenna may receive, send, and/or both receive and send various signals, such as various radio frequency signals. In some embodiments, the at least one radio and/or the at least one antenna may be configured for various wireless communication protocols, including but not limited to one or more of: WiFi, Bluetooth, NFC (near field communication), ZigBee, RFID, and/or the like. In some embodiments, the at least one radio and/or the at least one antenna may then be configured to facilitate one or more mobile payment systems, such as ApplePay, Google Wallet, Chargepoint, Paypal, and/or the like. Such embodiments may be facilitated by one or more mobile computing devices 9040 that may be in wireless communication with the at least one radio and/or the at least one antenna.

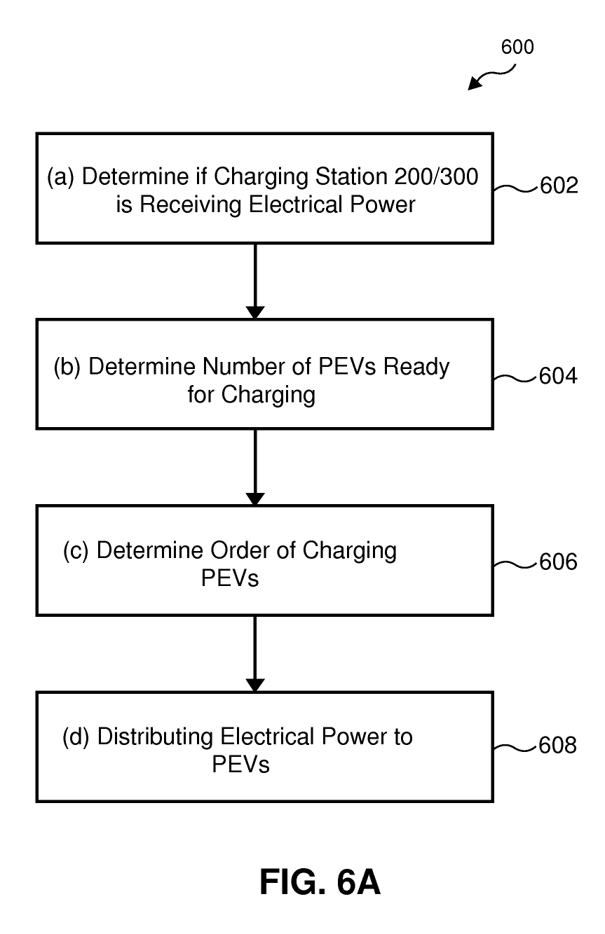

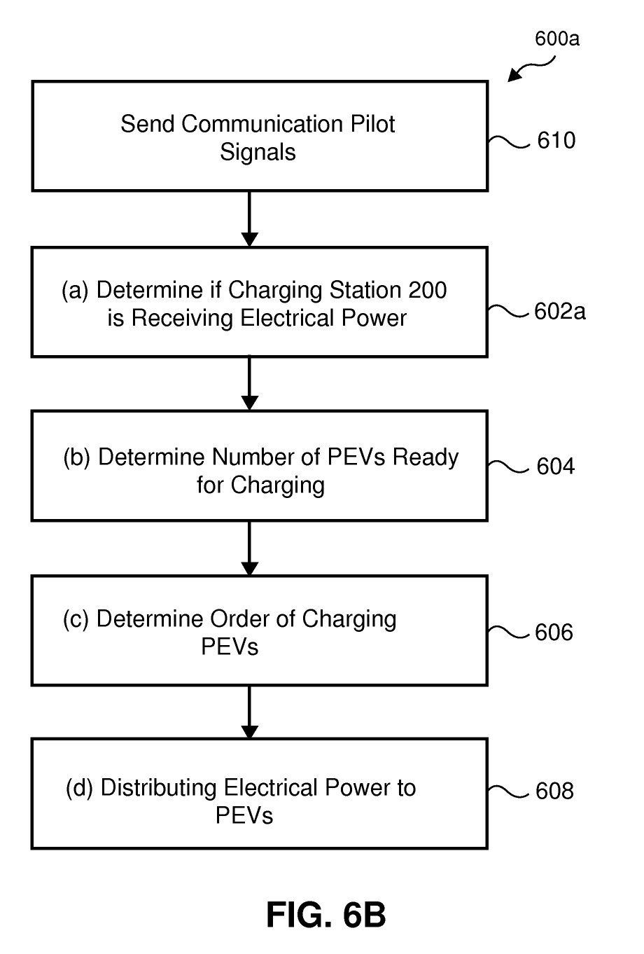

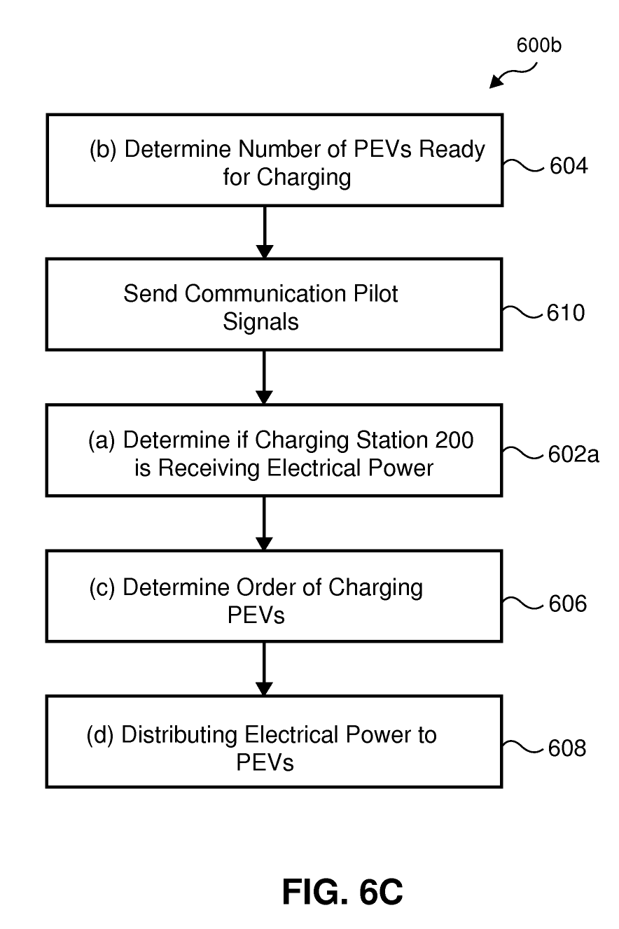

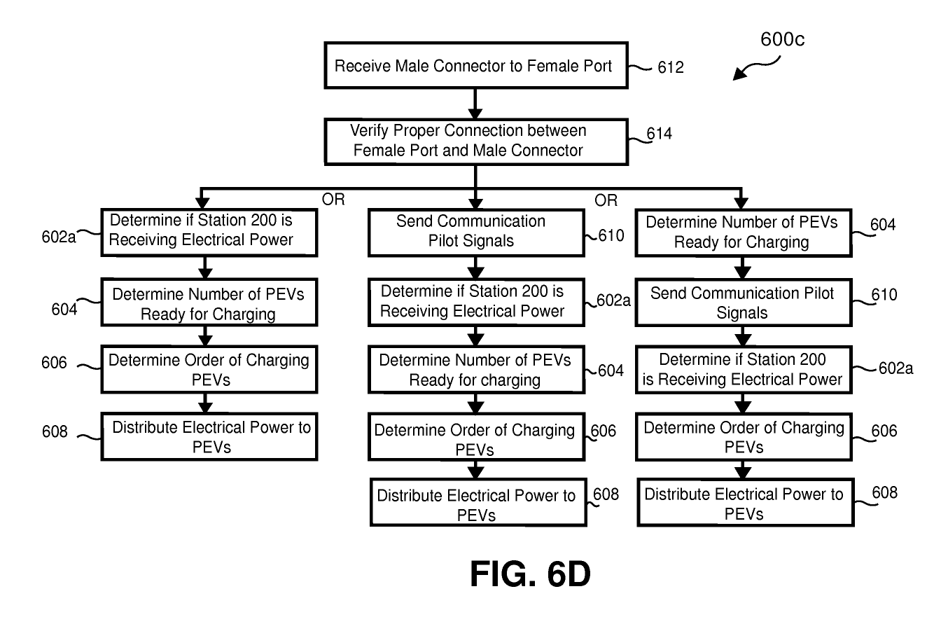

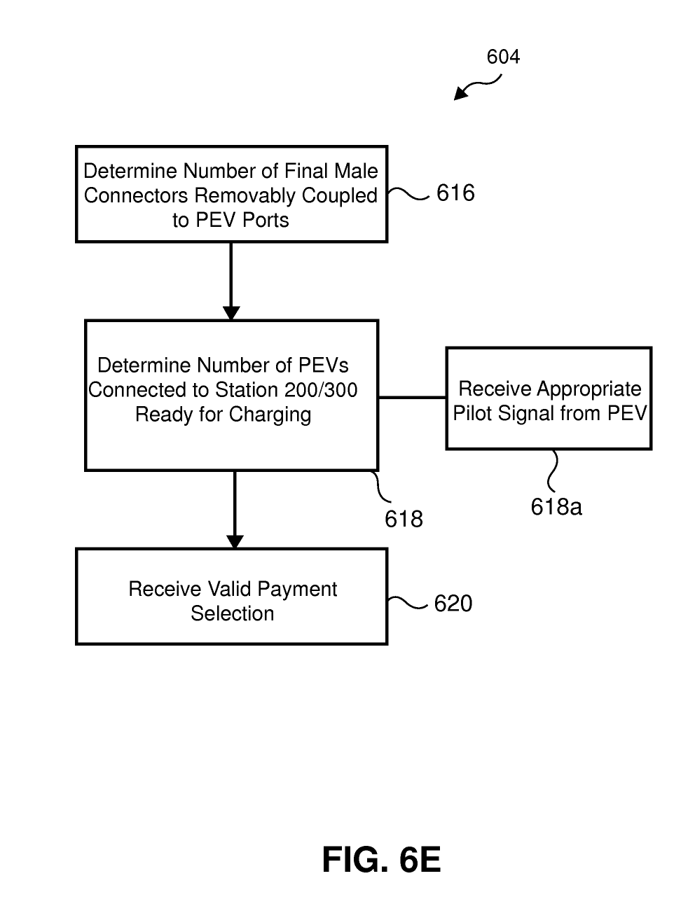

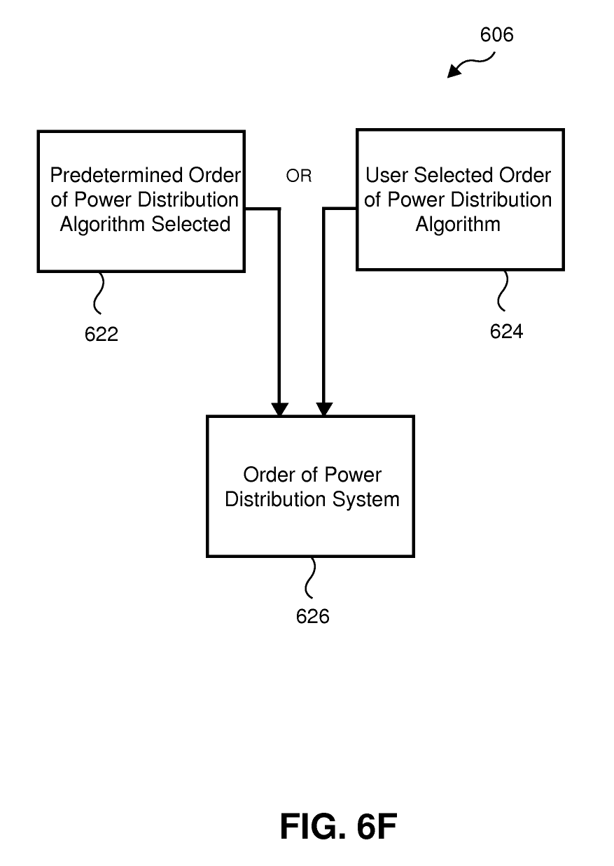

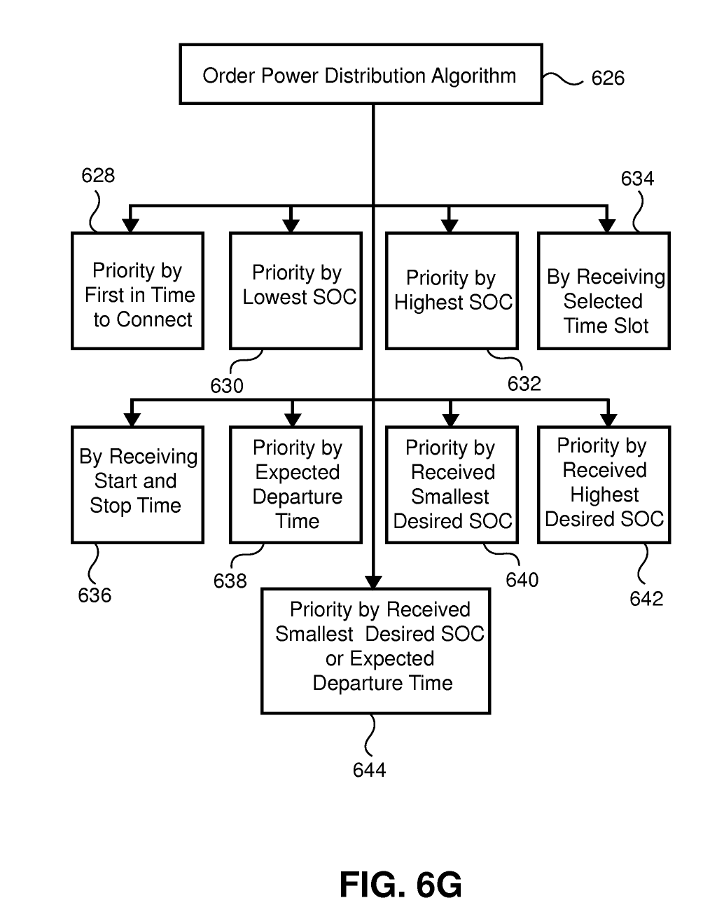

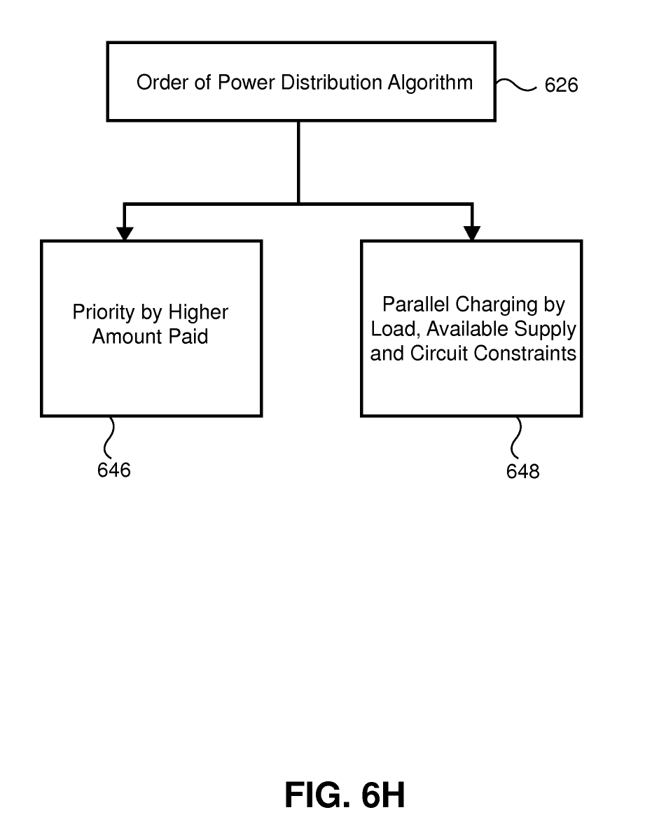

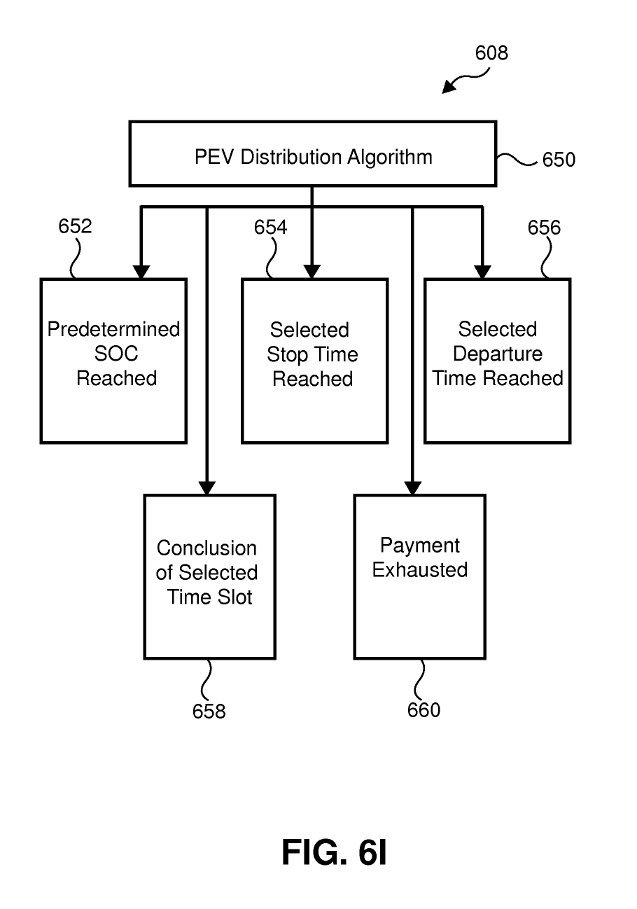

In some embodiments, a valid payment selection may be selected from one or more of the of the following: payment via a credit card; payment via Chargepoint; payment via Paypal; payment via a mobile payment system, payment via ApplePay, payment via Google Wallet, payment via cash (coins and/or currency bills), combinations thereof, and/or the like. In some embodiments, via a step 620, receipt of the valid payment selection may be required before any given PEV 9030 may be receiving any charging (i.e. before receiving any distribution of electrical power). See e.g., FIG. 6E.

Continuing discussing FIG. 2C, in some embodiments, controller 220 may comprise a safety problem detector 252. In some embodiments, safety problem detector 252 may be in electrical communication with processor 224 (either directly or via the internal bus). In some embodiments, such electrical communication may be via electrical wiring. In some embodiments, when safety problem detector 252 may detect a safety problem, transmission of electrical power to two or more PEVs 9030 may be terminated.

For example, and without limiting the scope of the present invention, in some embodiments, electrical power transmission to the one or more PEVs 9030 that may be removably attached to charging station expander 200 may be terminated by controller 220 causing to send a variation of the communication pilot signal to female port 202, which may then be transmitted to the respective male connector 9014. Where, in some embodiments, this variation in the communication pilot signal may mimic a status of male connector 9014 that may not be connected to a given PEV or that may mimic a status of connected but not ready for power transmission, which in either case may then cause the existing charging station 9010 to cease any meaningful power transmission (i.e. pilot signals may still be permitted) to charging station expander 200.

For example, and without limiting the scope of the present invention, in some embodiments, electrical power transmission to the one or more PEVs 9030 that may be removably attached to the charging station expander 200 may be terminated by controller 220 causing an engaged switch 212 to transition to the non-engaged operational state where there is no electrical power transmission.

In some embodiments, safety problem detector 252 may comprise one or more of: an accelerometer, a gyroscopic sensor, an inertial measurement sensor, a hygrometer, a moisture sensor, or the like. In some embodiments, the accelerometer, the gyroscopic sensor, and/or the inertial measurement sensor may each detect motion of charging station expander 200. In some embodiments, if any such detected motion may be greater than a predetermined threshold of acceptable motion, then safety problem detector 252 may treat such detected motion as the safety problem. Wherein in if such motion may be detected, controller 220 may then cause one or more switches 212 to transition to the non-engaged operational state; and/or may cause existing charging station 9010 to cease meaningful power transmission to charging station expander 200. Such detected motion may be indicative of a tampering problem and/or of an improper impact to charging station expander 200. Likewise, in some embodiments, the hygrometer and moisture may sensor each detect moisture. In some embodiments, when such detected moisture may be greater than a predetermined threshold of acceptable moisture, the safety problem detector 252 may treat such detected the moisture as the safety problem, causing controller 220 to act as noted in causing meaningful power transmission to removably connected PEVs 9030 to cease.

FIG. 2D may depict an exterior perspective view of charging station expander 200. FIG. 2E may depict a front view of the charging station expander 200. In these views, internal components of housing 270 may not be visible, such as controller 220, switch relay 210, the switches 212, power wiring, communication wiring, and/or the like.

In some embodiments, at least a portion of exterior 272 of the housing 270 may comprise a region for displaying 275 one or more of a graphic, a brand, or a trademark.

In some embodiments, each final male connector 216 may be configured according to a SAE J1772 standard to be coupled with port 9032 of each PEV 9030 selected from two or more PEVs 9030. (SAE may refer to SAE International, which may be an acronym for Society of Automotive Engineers, which may be US based, but globally active professional association and standards organization for engineering professionals in various industries, such as the automotive industry. SAE has and continues to develop communication and electrical power transmission standards (protocols) for PEVs 9030.) Note each port 9032 may also be configured according to the SAE J1772 standard. In some embodiments, each final male connector 216 may comprise five pins, with two of the five pins configured to distribute at least a portion of the at least some of the electrical power, a third of the five pins connected to ground, a fourth of the five pins for communicating pilot signals, and a final pin, a fifth, with a proximity sensor. See e.g., FIG. 2D. This five pin arrangement may be used in the SAE J1772 standard. The proximity sensor may indicate when a given final male connector 216 may be safely and/or properly removably connected (coupled) to a given port 9032. In some embodiments, this proximity sensor may be longer than any of the other pins, such as, but not limited to the other four remaining pins.

In some embodiments, each final male connector 216 may be configured according to one of the following standards: SAE J1772, SAE J2836/1-6, SAE J2847/1-5, a standard permitting communication of one or more of: a state of charge (SOC) of the PEV 9030 removably connected to the given final male connector 216, a vehicle identification of the PEV 9030 removably connected to the given final male connector 216, a user-account associated with the PEV 9030 removably connected to the given final male connector 216, and/or the like. Note, each port 9032 may also be configured to a corresponding complimentary standard to removably couple with the given final male connector 216.

In some embodiments, with respect to any given user 9050, user information may comprise the user-account. In some embodiments, PEV information (specific to a given PEV 9030) may comprise the SOC and/or the vehicle identification (ID).

In some embodiments, housing 270 may comprise a door 273, an openable door 273, that may be lockable in some embodiments. Such a door 273 may permit access to an interior of housing 270 for inspection, maintenance, updates, and/or repairs of controller 220, of switch relay 210, of switches 212, of power wiring, or communication wiring, and/or the like. See e.g., FIG. 2D.

FIG. 2F may depict a back view of charging station expander 200 depicted in FIG. 2D, showing female port 220. Note, while female port 220 may be shown accessible from a back exterior 272 of housing 270, in other embodiments, female port 220 may be located and/or assessable from any other side of housing 270 or bottom of housing 270 or top of housing 270.

In some embodiments, female port 202 may be configured according to the SAE J1772 standard to be removably coupled with the male connector 9014 that may also be configured according to the SAE J1772 standard. In some embodiments, female port 202 may comprise five receptacles, with two of the five receptacles configured to receive electrical power, a third of the five receptacles connected to ground, a fourth of the five receptacles for communicating pilot signals, and a final receptacle to be paired with a proximity detector of the male connector 9014. See e.g., FIG. 2F.

In some embodiments, female port 202 may be configured according to one of the following standards: SAE J1772, SAE J2836/1-6, SAE J2847/1-5, or a standard permitting communication that a device is ready to receive the electrical power. In some embodiments, male connector 9014 may also be configured to a corresponding complimentary standard to removably couple with female port 202.

In some embodiments, female port 202 may comprise a tamper resistant device. For example, a hinged cap to female port 202 shown in FIG. 2F may be modified into the tamper resistant device. In some embodiments, the tamper resistance device may mitigate against uncoupling of male connector 9014 from female port 202. For example, and without limiting the scope of the present invention, a purpose of the tamper resistant device may be to prevent or mitigate against uncoupling of the existing charging station's male connector 9014 from the charging station expander 200's female port 202. For example, and without limiting the scope of the present invention, the tamper resistance device may substantially enclose a portion of an exterior body of the male connector 9014 once male connector 9014 may be connected to female port 202, such that tugging on cable 9012 may likely not result in decoupling of male connector 9014 from female port 202. In some embodiments, the tamper resistant device may comprise two hemispheres which may join together and substantially enclose the portion of the exterior body of the male connector 9014 once male connector 9014 may be connected to female port 202, such that tugging on cable 9012 may likely not result in decoupling of male connector 9014 from female port 202. These two hemispheres may be lockable, e.g., with a padlock.

FIG. 2F may also depict one or more mounting structures 274 of housing 270. As shown in FIG. 2F these mounting structures 274 may be a set of four threaded holes for receiving a bolt per each threaded hole for mounting purposes.

FIG. 2G may depict a top view of charging station expander 200 depicted in FIG. 2D.

FIG. 2H may depict a bottom view of charging station expander 200 depicted in FIG. 2D. FIG. 2H may depict one or more mounting structures 274 of housing 270. As shown in FIG. 2H these mounting structures 274 may be a set of four threaded holes for receiving a bolt per each threaded hole for mounting purposes. FIG. 2H may also depict portions of two or more power distribution cables 214 emerging from exterior 272. In other embodiments, the portions of one or more power distribution cables 214 may emerge from exteriors 272 of any side, bottom, front, or top of housing 270.

FIG. 2I may depict a left side view of charging station expander 200 depicted in FIG. 2D. Note, in some embodiments, a right side view may be substantially equivalent in terms of structures and geometry shown as with the left view, aside from variations in door 273, hinge, LED placement and the like. In some embodiments, either side may comprise one or more mounting structures 274, emerging one or more power distribution cables 214, LEDs and/or the like.

FIG. 2J may depict charging station expander 200 comprising one or more mounting structures 274. In some embodiments, at least some of exterior 272 of housing 270 may comprise one or more mounting structures 274. In some embodiments, wherein the one or more mounting structures 274 may permit attaching charging station expander 200 to one or more of: existing charging station 9010, a wall, a girder, a frame, a stud or a substrate (e.g., a floor or a ground). In some embodiments, one or more mounting structures 274 may comprise structure(s) (e.g., flanges) for welding to another appropriate metal, for example a metal of existing charging station 9010, the wall, the girder, the frame, the stud or the substrate. See e.g., FIG. 2J. In FIG. 2J, the one or more mounting structures 274 depicted may be flanges. In some embodiments, bolts and/or screws may pass through a center hole of such flanges. In some embodiments, one or more mounting structures 274 may comprise structure(s) for receiving bolts and/or screws. In FIG. 2F and in FIG. 2H, the one or more mounting structures 274 depicted may be threaded holes for receiving bolts or screws.

FIG. 2K may depict charging station expander 200 comprising safety structure 276 that may protect charging station expander 200 from impacts and/or from tampering. In some embodiments, housing 270 or charging station expander 200 may comprise safety structure 276 to mitigate against impacts to charging station expander 200, where such impacts may cause damage to charging station expander 200. Such safety structure 276 may also minimize undesirable tampering with charging station expander 200. In some embodiments, safety structure 276 may comprises a cage substantially circumscribing exterior 272 of housing 270. In some embodiments, such a cage may be in physical contact with at least a portion of exterior 272. In some embodiments, such a cage may not be in physical contact with exterior 272. In some embodiments, such a cage may be configured to still permit the door 273 of housing 270 to be openable so that the interior of housing 270 may be accessed, e.g., for inspection and/or maintenance of controller 220 and/or of switch relay 210. In some embodiments, such a cage may be removable such that the door 273 of housing 270 may be openable so that the interior of housing 270 may be accessed, e.g., for inspection and/or maintenance of controller 220 and/or of switch relay 210. In some embodiments, safety structure 276 may be substantially constructed of rigid to semi-rigid materials of construction. In some embodiments, safety structure 276 may be substantially constructed of one or more of steel, carbon fiber, and/or thermos formed plastics.

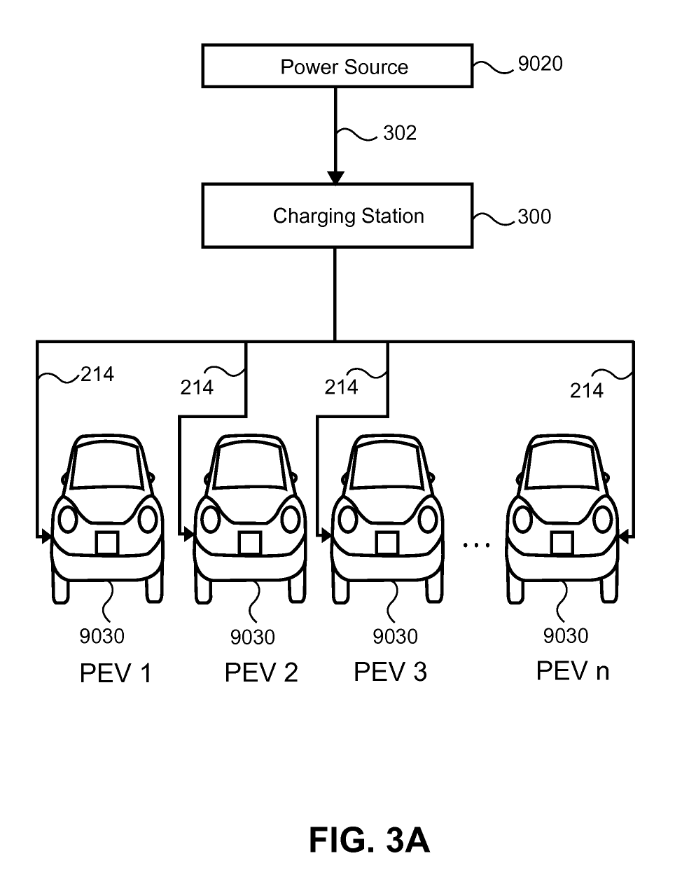

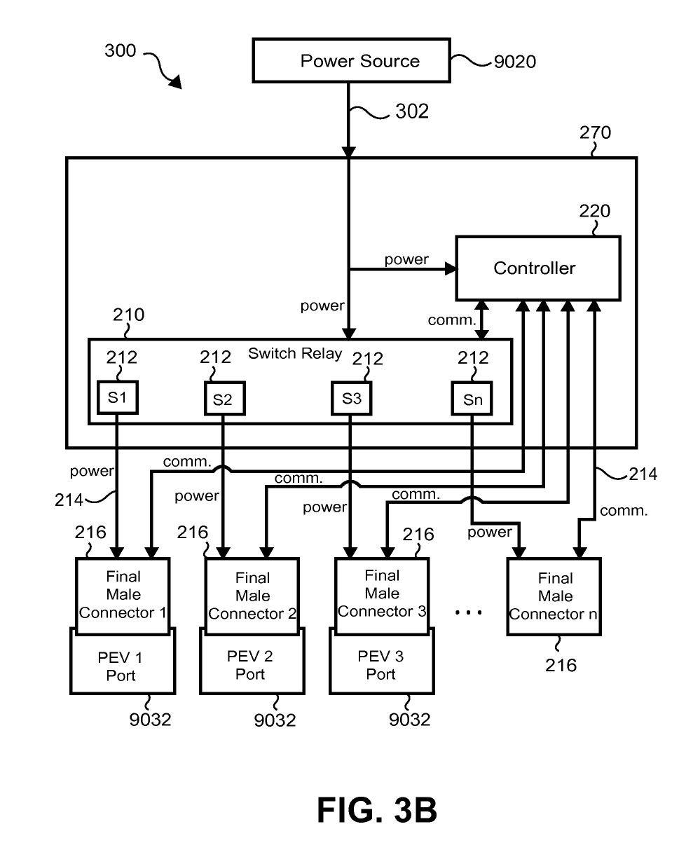

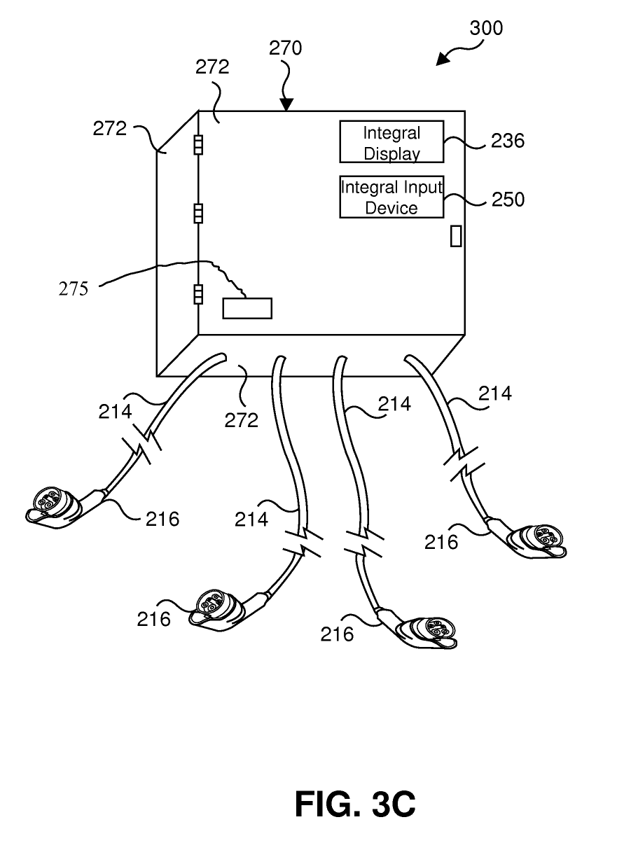

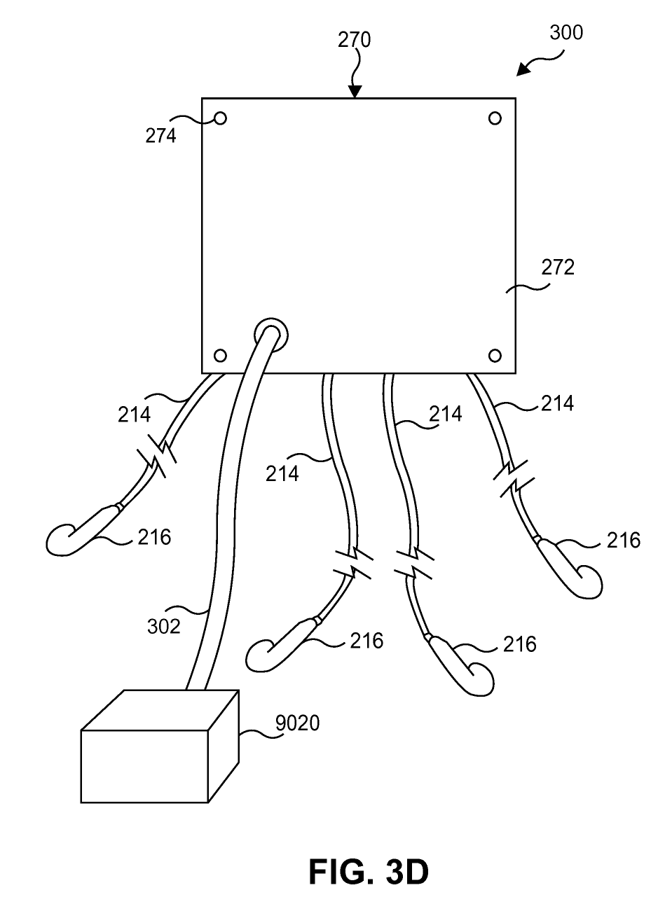

A FIG. 3 series of figures may comprise FIG. 3A through FIG. 3D. These FIG. 3 series figures may focus on a charging station 300 and on various embodiments of such a charging station 300. In summary, charging station 300 may be a synergistic combination of charging station expander 200 and existing charging station 9010 into one single device. That is, charging station expander 200 may be useful in retrofitting existing charging stations 9010 that have already been installed at various parking spots; whereas, charging station 300 may be desirable for installs at parking spots which do not yet have any type of charging station installed. So where charging station expander 200 may obtain substantially all electrical power from existing charging station 9010; charging station 300 may receive substantially all electrical power directly from a connection to the grid or a power source 9020. Thus, in some embodiments, of charging station 300, there may be no female port 202.

FIG. 3A may depict a block diagram showing an exemplary embodiment of a single charging station 300 in use removably connected simultaneously to a plurality of PEVs 9030 (two or more PEVs 9030).

In some embodiments, charging station 300 may comprise: switch relay 210, two or more distribution cables 214, controller 220, and housing 270. In some embodiments, charging station 300 may comprise: a connection 302 to power source 9020 of the electrical power, switch relay 210, two or more distribution cables 214, controller 220, and housing 270. In some embodiments, connection 302 may be a hard wired connection between charging station 300 and power source 9020. In some embodiments, connection 302 may configured to prevent or minimize de-coupling between charging station 300 and power source 9020. That is, in some embodiments, de-coupling of connection 302 between charging station 300 and power source 9020 may require use of tools and/or a shutdown of power to power source 9020. Aside from maintenance and/or repair needs, connection 302 may be intended to a permanent physical hard wired connection.

In some embodiments, switch relay 210 of charging station 300 may be substantially the same as switch relay 210 described above as a component of charging station expander 200. In some embodiments, two or more distribution cables 214 of charging station 300 may be substantially the same as two or more distribution cables 214 described above as a component of charging station expander 200. In some embodiments, controller 220 of charging station 300 may be substantially the same as controller 220 described above as a component of charging station expander 200. Except in some embodiments of charging station 300, the software non-transitorily stored in memory 222 of controller 220 may not comprise code for sending communication pilot signals to female port 202, since charging station 300 may not comprise female port 202. In some embodiments, housing 270 of charging station 300 may be substantially the same as housing 270 described above as a component of charging station expander 200. Except in some embodiments of charging station 300, housing 270 may not comprise a point of attachment of female port 202, but instead connection 302 may extend from exterior 272 of housing 270 in some charging station 300 embodiments. Likewise, as noted above for charging station expander 200, in some embodiments, charging station 300 may comprise one or more of surge protectors, power conditioners, rectifiers/inverters/converters, and/or transformers for each circuit of charging station 300.

FIG. 3B may depict a block diagram of charging station 300, but shown in more detail. Note similarities and differences in FIG. 3B with FIG. 2B. In FIG. 3B there may be no female port 202. Instead, in some embodiments of charging station 300, connection 302 may replace female port 202.

FIG. 3C may depict an exterior perspective view of charging station 300. In some embodiments, from this front perspective view, charging station 300 as depicted in FIG. 3C may be substantially equivalent both structurally and geometrically to charging station 200 as depicted in FIG. 2D.

FIG. 3D may depict a back view of charging station 300 depicted in FIG. 3C, showing a hard wired connection to the grid or to a power source. Note similarities and differences in FIG. 3D with FIG. 2F. In FIG. 3D there may be no female port 202. Instead, in some embodiments of charging station 300, connection 302 may replace female port 202.

FIG. 4A may depict a block diagram of an exemplary system 400 utilizing one or more charging station expanders 200 in conjunction with one or more servers 410. In some embodiments, system 400 may be for distributing electrical power to two or more PEVs 9030 from one or more charging station expanders 200. In some embodiments, one or more servers 410 may be used to one or more of: control, monitor, deliver software and/or firmware updates, facilitate payment, and/or the like with respect to one or more charging station expanders 200 that may be in communication with one or more servers 410. Monitoring may comprise one or more of remote status monitoring of each single charging station expander 200 or remote status monitoring of two or more PEVs 9030 removably connected to each single charging station expander 200. Controlling may comprise being able to select or determine the order of power distribution algorithm 626, select or determine the PEV distribution algorithm 650, or power up or power down a given charging station expander 200. In various embodiments of system 400, each single charging station expander 200 may be removably connected to two or more PEVs 9030. In some embodiments, system 400 may comprise one or more charging station expanders 200 and one or more servers 410. In some embodiments, system 400 may comprise one or more charging station expanders 200, one or more servers 410, and network 420. As noted above under the discussion of charging station expander 200, each single charging station expander 200 may be for receiving the electrical power from existing charging station 9010 and distributing the electrical power received (or a portion thereof) to two or more PEVs 9030.

In some embodiments, one or more servers 410 may be in communication with each controller 220 via one or more of network adapter 226, the modem, and/or the router. In some embodiments, communication between one or more servers 410 and one or more charging station expanders 200 may be by direct wired or direct wireless communications, or combinations thereof. For example, when one or more server 410 and one or more charging station expanders 200 are deployed physically sufficiently close to each other, then communication between the one or more servers 410 and one or more charging station expanders 200 may be by direct wired or direct wireless communications, without use of network 420.

In some embodiments, communication between one or more servers 410 and one or more charging station expanders 200 may be indirect where communications may transverse network 420. For example, and without limiting the scope of the present invention, communication between the one or more servers 410 and controllers 220 of each charging station expander 200 of may be over network 420. In some embodiments, network 420 may be selected from one or more of the LAN, the WAN, the internet, and/or the like.

FIG. 4B may depict an environment in which charging station expanders 200 may be used. FIG. 4B may depict a block diagram of an exemplary system 450 utilizing one or more charging station expanders 200 in conjunction with one or more servers 410.

In some embodiments, system 450 may be for distributing electrical power to two or more PEVs 9030 from one or more charging station expanders 200. In some embodiments, one or more servers 410 may be used to one or more of: control, monitor, deliver software and/or firmware updates, facilitate payment, and the like with respect to one or more charging station expanders 200 that may be in communication with one or more servers 410. Monitoring may comprise one or more of remote status monitoring of each single charging station expander 200 or remote status monitoring of two or more PEVs 9030 removably connected to each single charging station expander 200. Controlling may comprise being able to select or determine the order of power distribution algorithm 626, select or determine the PEV distribution algorithm 650, or power up or down a given charging station expander 200. In various embodiments of system 450, each single charging station expander 200 may be removably connected to two or more PEVs 9030. In some embodiments, system 450 may comprise one or more charging station expanders 200 and one or more servers 410; and one or more of: network 420, one or more existing charging stations 9010, one or more power sources 9020, two or more PEVs 9030, one or more mobile computing devices 9040, or user 9050.

In some embodiments, one or more servers 410 may be in communication with each controller 220 via one or more of network adapter 226, the modem, and/or the router. In some embodiments, communication between one or more servers 410 and one or more charging station expanders 200 may be by direct wired or direct wireless communications, without using network 420. For example, when one or more server 410 and one or more charging station expanders 200 are deployed physically sufficiently close to each other, then communication between the one or more servers 410 and one or more charging station expanders 200 may be by direct wired or direct wireless communications, without use of network 420.

In some embodiments, communication between one or more servers 410 and one or more charging station expanders 200 may be indirect where communications may transverse network 420. For example, and without limiting the scope of the present invention, communication between the one or more servers 410 and controllers 220 of each charging station expander 200 of may be over network 420. In some embodiments, network 420 may be selected from one or more of the LAN, the WAN, the internet, and the like.

In some embodiments, system 450 may further comprise one or more existing charging stations 9010. Each existing charging station may be removably connected to a given charging station expander 200. In some embodiments, existing charging station 9010 may comprise cable 9012. In some embodiments, cable 9012 may comprise male connector 9014 such that cable 9012 may terminate in male connector 9014. In some embodiments, existing charging station 9010 may receive the electrical power from one or more power sources 9020 and may then transmit that received electrical power through cable 9012 to male connector 9014.

In some embodiments, male connector 9014 may be configured according to the SAE J1772 standard for coupling with a given port 9032 of a given PEV 9030 that may also configured according to the SAE J1772 standard. In some embodiments, male connector 9014 may comprise five pins, with two of the five pins configured to distribute at least some of the electrical power, one of the five pins connects to ground, one of the five pins for communicating pilot signals, and a final pin with a proximity detector. However, note in system 450 embodiments, male connector 9014 may not be removably connected to any given port 9032, but rather male connector 9014 may be (removably) connected to female port 202 of a given charging station expander 200.

In some embodiments, male connector 9014 may be configured according to one of the following standards: SAE J1772, SAE J2836/1-6, SAE J2847/1-5, or a standard permitting communication that a device is ready to receive the electrical power. A receiving port for removably receiving male connector 9014 may be also configured to a corresponding complimentary standard.

In some embodiments, one or more power sources 9020 may refer to an access point or connection point with a source of electrical power, such as the grid providing electrical power from a utility entity or other source provider of electrical power. Generally, such source providers of electrical power charge via some mechanism for consumption of electrical power provided by the source provider. Source providers may also be from individual residences and/or individual businesses that may be producing their own electrical power from various means, such as, but not limited to, solar, wind, geothermal, gas, coal, hydroelectric, wave, tidal, fuel cell, battery, and combinations thereof.

In some embodiments, system 450 may further comprise two or more PEVs 9030. In some embodiments, each PEV 9030 selected from two or more PEVs 9030 may comprise port 9032. In some embodiments, port 9032 may be configured according to the SAE J1772 standard to be removably coupled with a given final male connector 216 that may also be configured according to the SAE J1772 standard. In some embodiments, port 9032 may comprise five receptacles, with two of the five receptacles configured to receive at least a portion of the at least some of the electrical power, one of the five receptacles connects to ground, one of the five receptacles for communicating pilot signals, and a final receptacle to be paired with a proximity sensor of final male connector 216.

In some embodiments, port 9032 may be configured according to one of the following standards: SAE J1772, SAE J2836/1-6, SAE J2847/1-5, or a standard permitting communication that a device is ready to receive the electrical power. Final male connector 216 may also be configured to a corresponding complimentary standard to removably couple with port 9032.

In some embodiments, each PEV 9030 selected from the two or more PEVs 9030 may comprise a repository. The repository may be a medium for non-transitory storage of one or more of electric files, data, software, code, or firmware. In some embodiments, the repository may non-transitorily store information of one or more of: user information or PEV information. In some embodiments, the PEV information may comprise one or more of: SOC of the PEV 9030 in near real time, whether a proper connection is detected between port 9032 and the final male connector 216, or whether the PEV 9030 determines that the PEV 9030 is ready for battery charging.

In some embodiments, with respect to any given user 9050, user information may comprise the user-account. In some embodiments, PEV information (specific to a given PEV) may comprise the SOC and/or the vehicle identification (ID) with respect to that given PEV.

In some embodiments, the repository may be in electrical communication with port 9032. At least some of the information (e.g. the SOC information) non-transitorily stored in the repository may be transmitted from the repository, to port 9032, and then via a pilot signal (or other communication signal) through dedicated wiring that passes within power distribution cable 214 selected from two or more power distribution cables 214, and then on to controller 220. Controller 220 may process this information communicated from PEV 9030. Controller 220 may transmit this information to one or more servers 410 and/or to integral display 236.

In some embodiments, system 450 may further comprise one or more mobile computing devices 9040. In some embodiments, one or more mobile computing devices 9040 may be used to one or more of: control, monitor, initiate and/or accept software and/or firmware updates, facilitate payment, enter one or more user inputs directed to controller 220, and/or the like with respect to one or more charging station expanders 200 that may be in communication with one or more mobile computing devices 9040. Monitoring may comprise one or more of remote status monitoring of each single charging station expander 200 or remote status monitoring of two or more PEVs 9030 removably connected to each single charging station expander 200. Controlling may comprise being able to select or determine the order of power distribution algorithm 626, select or determine the PEV distribution algorithm 650, or power up or down a given charging station expander 200.

In some embodiments, one or more mobile computing devices 9040 may be selected from one or more of a smartphone, a tablet computing device, a laptop computer, a computer integral to the PEV 9030, a handheld computing device, a smartwatch, or a wearable computing device.

In some embodiments, one or more mobile computing devices 9040 may be in communication with controller 220 via one or more network adapter 226, the modem, and/or the router. Such communication may be one or more of direct wired or direct wireless communication. In some embodiments, one or more mobile computing devices 9040 may be in indirect communication with controller 220 with communications utilizing network 420.

In some embodiments, one or more mobile computing devices 9040 may be in communication with the repository and information non-transitorily stored in the repository may be transmitted to one or more mobile computing devices 9040.

In some embodiments, system 450 may further comprise at least one user 9050 of system 450. For example, and without limiting the scope of the present invention, at least one user 9050 of system 450 may be selected from one or more of: a driver of a given PEV 9030, a user of a given PEV 9030, a parking attendant of a given PEV 9030, a user of a given charging station expander 200, a user of a given existing charging station 9010. Such users 950 may interact and deliver inputs to system 450 and/or receive outputs from system 450 by use of one or more of: one or more mobile computing devices 9040, integral input devices 250, integral display 236, or input/output devices associated with one or more servers 410.

In some embodiments, user 9050 may be a system operator or system administrator. Such users may access system 450 via the input/output devices associated with one or more servers 410. Such users may access system 450 via one or more mobile computing devices 9040 in communication with one or more servers 410.

Thus in some embodiments and/or applications user 9050 may be an end user (consumer) of electrical power or may be associated with a source provider of electrical power or with an entity managing PEV power distribution.

In terms of the environment of operation that FIG. 4B may depict, a given charging station expander 200, existing charging station 9010, power source 9020, and two or more PEVs 9030 may be all be local and proximate to each other. For example, and without limiting the scope of the present invention, this may be within 100 feet. Whereas, locations of one or more servers 410, one or more mobile computing devices 9040, and/or users 9040 may be located remotely. Such as over 100 feet and could be separated by many miles, only limited by communications across network 420.

FIG. 5A may depict a block diagram of an exemplary system 500 utilizing one or more charging stations 300 in conjunction with one or more servers 410. In some embodiments, system 500 may be nearly identical with system 400, with an exception that the one or more charging station expanders 200 of system 400 may be replaced with one or more charging stations 300 in system 500.

In some system embodiments, system 400 and system 500 may be combined, in that such a system may comprise one or more of: one or more charging station expanders 200 or one or more charging stations 300.

FIG. 5B may depict an environment in which charging stations 300 may be used.

FIG. 5B may depict a block diagram of an exemplary system 550 utilizing one or more charging stations 300 in conjunction with one or more servers 410. In some embodiments, system 550 may be nearly identical with system 450, with an exception that the one or more charging station expanders 200 of system 450 may be replaced with one or more charging stations 300 in system 550.

In some system embodiments, system 400, system 450, system 500, and system 500 may be combined, in that such a resulting system may comprise one or more of: one or more charging station expanders 200 or one or more charging stations 300.

FIG. 6A may depict a flow diagram showing steps of an exemplary method 600 of distributing electrical power to at least one PEV 9030 removably connected to charging station expander 200 or charging station 300, when two or more PEVs 9030 may be removably connected to charging station expander 200 or charging station 300. In some embodiments, method 600 may comprise steps 602, 604, 606, and 608. Note FIG. 6B may depict method 600a, FIG. 6C may depict method 600b, and FIG. 6D may depict method 600c. Methods 600a, 600b, and 600c may all be variations of method 600, although methods 600a, 600b, and 600c may be limited to charging station expander 200.

Continuing discussing FIG. 6A, in some embodiments, step 602 may comprise determining if charging station expander 200 may be receiving the electrical power from existing charging station 9010; or determining if charging station 300 may be receiving the electrical power from power source 9020. That is, step 602 may be conceptualized as a step of determining and/or verifying power supply availability and/or proper connections with power supplies, where power supplies may be one or more of existing charging station 9010 or power source 9020.

In some embodiments, step 602 may further comprise additional sub-steps, such as, but not limited to, a step of receiving male connector 9014 at female port 202. In some embodiments, step 602 may further comprise additional sub-steps, such as, but not limited to, a step of controller 220 verifying that female port 202 may have a proper connection (removable connection) with male connector 9014 of existing charging station 9010. For example, and without limiting the scope of the present invention, this verification may be facilitated by controller 220 initiating the communication pilot signal to female port 202; wherein the communication pilot signal may mimic a pilot signal. These example sub-steps may be applicable to methods working with charging station expander 200.

In some embodiments, step 604 may comprise determining how many PEVs 9030 selected from the two or more PEVs 9030 may be both removably coupled to a given final male connector 216 selected from one or more final male connectors 216 of charging station expander 200 or of charging station 300; and wherein such removably coupled PEVs 9030 may also be ready to accept (receive) distribution of at least some of the electrical power. Step 604 may be expanded upon in FIG. 6E.

Continuing discussing FIG. 6A, in some embodiments, step 606 may comprise determining an order of charging the PEVs 9030 determined in step 604, by applying an order of power distribution algorithm 626 to the PEVs 9030 determined in step 604. Step 606 may be expanded upon in FIG. 6F, FIG. 6G, and in FIG. 6H. Determining the order of charging the PEVs 9030 determined in step 604 may take into account various demands, such as, but not limited to, timing of PEV 9030 connection to male connectors 216, PEV 9030 SOC (state of charge), desired start and stop times of charging, desired time slots for charging, expected departure times for a given PEV 9030, payment (received and/or authorized), and/or the like.

Continuing discussing FIG. 6A, in some embodiments, step 608 may comprise distributing the at least some of the electrical power to at least a given PEV 9030 per the order of charging in step 606. Distribution of the at least some of the electrical power may proceed according a PEV distribution algorithm 650 before switching distribution to a next PEV 9030 per the order of charging in step 606. That is step 608 may be conceptualized as a step of satisfying demand. While step 606 may determine the order of charging a given PEV 9030 removably coupled to a given final male connector 216; step 650 may determine how charging actually proceeds (progresses) to the PEV 9030 assigned to be presently charged for the order of charging. Step 650 may be expanded upon in FIG. 6I.

FIG. 6B may depict a flow diagram showing steps of exemplary method 600a of distributing electrical power to at least one PEV 9030 selected from two or more PEVs 9030 utilizing charging station expander 200. In some embodiments, method 600a may be substantially similar to method 600, but that method 600a may comprise an additional step 610 that may precede step 602; and that in method 600a step 602 may be replaced with step 602a.

Step 602a may differ from step 602, in that in step 602a this step may only be determining if charging station expander 200 may be receiving the electrical power; whereas in step 602, the process may be determining if charging station expander 200 or charging station 300 may be receiving the electrical power.

In some embodiments, step 610 may comprise sending a communication pilot signal from controller 220 of charging station expander 200 to female port 202 of charging station expander 200 for communication to male connector 9014 of existing charging station 9010. In some embodiments, the communication pilot signal may mimic a pilot signal from a PEV 9030 with a status of connected and ready to receive electrical power such that existing charging station 9010 may then distribute the electrical power to charging station expander 200. Once, existing charging station 9010 receives this mimicking communication pilot signal, charging station 9010 may release electrical power to charging station 200 or may be ready to release electrical power to charging station 200.

Alternatively, in some embodiments, step 602 (i.e., an embodiment without step 602a) may additionally comprise sending the communication pilot signal from controller 220 of charging station expander 200 to female port 202 of charging station expander 200 for communication to male connector 9014 of existing charging station 9010.

FIG. 6C may depict a flow diagram showing steps of exemplary method 600b of distributing electrical power to at least one PEV 9030 selected from two or more PEVs 9030 utilizing charging station expander 200. In some embodiments, method 600b may comprise the steps of: 604, 610, 602a, 606, and 608. That is, in some embodiments, before controller 220 may send the communication pilot signal directed towards existing charging station 9010, controller 220 may first determine if there is at least one PEV 9030 according to the step 604. Recall, in some embodiments, step 604 comprised determining how many of PEVs 9030 selected from two or more PEVs 9030 may be both removably coupled to a given final male connector 216 selected from one or more final male connectors 216 of charging station expander 200 and that such PEVs 9030 may be ready to accept distribution of at least some of the electrical power.

FIG. 6D may depict a flow diagram showing alternative steps of exemplary method 600c of distributing electrical power to at least one PEV 9030 selected from two or more PEVs 9030 utilizing charging station expander 200. Method 600c may comprise one or two additional steps of step 612 and/or step 614 as compared against method 600, 600a, and 600b. In some embodiments, in method 600c, step 612 and/or step 614 may precede any of the steps described in methods 600, 600a, and/or 600b. That is, method 600c may present at least three alternative methods, an alternative to method 600, an alternative to method 600a, and an alternative to method 600b.

In some embodiments, step 612 may comprise receiving male connector 9014 of existing charging station 9010 at female port 202 of charging station expander 200, such that the male connector 9014 may be (removably) coupled (connected) to female port 202. See e.g., FIG. 2B.

Alternatively, in some embodiments, step 602a may comprise an initial sub-step of receiving male connector 9014 of existing charging station 9010 at female port 202 of charging station expander 200, such that the male connector 9014 may be (removably) coupled (connected) to female port 202.

Continuing discussing FIG. 6D, in some embodiments, step 614 may comprise verifying that female port 202 of charging station expander 200 may have a proper connection with male connector 9014 of existing charging station 9010.

Alternatively, in some embodiments, step 602a may comprise an initial sub-step of verifying that female port 202 of charging station expander 200 may have a proper connection with male connector 9014 of existing charging station 9010.

Note, in FIG. 6D, after step 614, method 600c may proceed in one of three options, as designated by the two logical operators of “OR” that separate these three options. The remaining steps of the first option of steps on the far left may correspond to method 600 (with an exception that here in method 600c, step 600 may be replaced with step 602a). The remaining steps of the second option of step, in the middle, may correspond to method 600a. The remaining steps of the first option of steps on the far right may correspond to method 600b. Each of these remaining steps coming after step 614 in FIG. 6D has been discussed above in FIG. 6A, FIG. 6B, and FIG. 6C.

FIG. 6E may depict a flow diagram depicting further detailed steps for determining a number of PEVs 9030 that may be ready for charging. That is, FIG. 6E may depict additional details of step 604.

In some embodiments, step 604 may comprise step 616 and step 618, and optionally step 620 in some embodiments. And step 618a may be a further sub-step of step 618.

In some embodiments, step 616 may comprise determining a number of final male connectors 216 that may be removably coupled to ports 9032 of PEVs 9030. In some embodiments, determining this number may be facilitated by the proximity sensor of each final male connector 216 and/or by the communication standard being used by both final male connectors 216 and ports 9032.

In some embodiments, step 618 may comprise determining a number of PEVs that may be removably connected to charging station expander 200 or to charging station 300 that may be ready for charging. This may be facilitated by step 618a, wherein controller 220 may receive appropriate pilot signals (or other similar communication signals) from the PEVs 9030 that may be ready for charging. Such signals may be conveyed (routed) through power distribution cables 214.

In some embodiments, step 604 may comprise an additional limitation of step 620, wherein a given PEV 9030 may not be deemed ready for charging unless an a valid payment selection may have been received for that given PEV 9030. In some embodiments, step 604 may further comprise requiring receiving a valid payment selection for any PEV 9030 to be considered in step 606 of determining the charging order.

In some embodiments, the valid payment selection may comprise receiving one or more of: credit card information, cash (including coins), or data sufficient to conclude electronic payment via a mobile payment system. Such information, currency, and/or data may be entered or input into charging station expander 200 or charging station 300 via integral input device 250 and/or via one or more mobile computing devices 9040 in communication with controller 220. In some embodiments, the valid payment selection may comprise receiving a basis for payment, wherein the basis for payment may be selected from one or more of the group consisting of: a desired SOC value, per incremental unit of SOC increased during distribution, per unit of time during distribution, or a time slot.

In some embodiments, a monetary value associated with the valid payment selection may be utilized by the order of power distribution algorithm 626 to determine priority of the order of charging by a highest monetary value paid, contracted to be paid, or committed to be paid. For example, and without limiting the scope of the present invention, a user 9050 (e.g., PEV 9030 driver) may pay a higher amount (i.e., higher monetary value) to increase the user's 9050 priority in the order of charging. Further in some embodiments, any other users 9050 (e.g., other PEV 9030 drivers) who may be effected by such a shift in priority in the order of charging may be notified and asked if they want to match or pay more to preserve their current priority in the order of charging, thus forming an auction for determining at least some of the charging order. See option 646 in FIG. 6H and discussed below in the FIG. 6H discussion.

FIG. 6F may depict a flow diagram depicting further detailed steps for determining the order of charging the PEVs 9030 that may have been determined in step 604. That is, FIG. 6F may depict additional details of step 606.

FIG. 6G and FIG. 6H together may depict eleven different options for determining this order of charging. That is, FIG. 6G and FIG. 6H may depict eleven different options of the order of power distribution algorithm 626. And FIG. 6F may depict two fundamental options for determining which of those eleven options may be used or selected. Fundamentally, the available options of the order of power distribution algorithm 626 may be determined by step 622 or step 624. See e.g., FIG. 6F. In some embodiments, step 622 may be mutually exclusive with step 624. Or in some embodiments, step 622 may determine the pool of options available and then step 624 may determine which of those options selected from the pool of options may be used.

In some embodiments, step 622 may comprise the options for the order of power distribution algorithm 626 being predetermined. That is, in step 622 one or more or a combination of these eleven options may be predetermined, that is determined prior to user 9050 having a given PEV 9030 charged by charging station expander 200 or by charging station 300. In some embodiments, this may be predetermined in the sense that these options may be set and determined in the software or code that may non-transitorily reside in memory 222. In some embodiments, this may be predetermined in the sense that these options may be set and determined by a system operator or a system administrator who may be responsible for operation and/or management of a given charging station expander 200, charging station 300, and/or server 410.

In some embodiments, in step 624 user 9050 may select one or more or a combination of these eleven options to utilize in determining the order of charging. Or alternatively, in step 624 user 9050 may selected from the options determined by step 622. Note in some embodiments or in some applications, user 9050 may be the system operator, the system administrator or the parking attendant.

In some embodiments, once a selection or determination of the order of the charging is made under step 622 or step 624, that order may govern the order of the charging until charging station expander 200 or charging station 300 detects no PEVs 9030 removably connected.

FIG. 6G may depict an organizational diagram showing various options for the order of power distribution algorithm 626, wherein such selected or predetermined options may determine the order of charging the PEVs 9030 that may be removably coupled (connected) to charging station expander 200 or charging station 300. And FIG. 6H may depict a continuation of the organizational diagram from FIG. 6G. Together FIG. 6G and FIG. 6H may depict eleven options of: 628, 630, 632, 634, 636, 638, 640, 642, 644, 646, and 648.

In some embodiments, the order of power distribution algorithm 626 may comprise determining the order of charging according to confirming a valid payment selection has been received for at least one PEV 9030 removably coupled with a given final male connector 216. In some embodiments, this valid payment selection requirement may be applied to any of the eleven options depicted in FIG. 6G and FIG. 6H.

In some embodiments, option 628 may be base order of charging priority on first in time to connect. In some embodiments, the order of power distribution algorithm 626 may comprise determining the order of charging according to an evaluation of timing for when each PEV 9030 became removably coupled to a given final male connector 216 should have charging initiated on a first in time to connect basis. In some embodiments, this order may be assigned in an ascending order of first to removably couple, beginning with the PEV 9030 that may be first removably coupled to a given final male connector 216 over later in time PEVs 9030 that become removably coupled to a given final male connector 216.

That is, in some embodiments, the order of power distribution algorithm 626 may comprise determining the order of charging according to a first PEV 9030 to be removably coupled to a given final male connector 216, via a given port 9032 of the first PEV 9030 being removably coupled to the given final male connector 216, receiving priority over later in time PEVs 9030 being removably coupled to a given final male connector 216.

In some embodiments, option 628 may further comprise determining the order by adding a required limitation that the first PEV 9030 also be ready to accept distribution of the at least some of the electrical power. In some embodiments, option 628 may further comprise determining the order by adding a required limitation that the first PEV 9030 or any PEV 9030 to be charged, also had provided the valid payment selection.

In some embodiments, option 630 may be base order of charging priority on lowest SOC detected or lowest SOC presented. In some embodiments, the order of power distribution algorithm 626 may comprise determining the order of charging according to an evaluation of SOC for each PEV 9030 removably coupled to a given final male connector 216. In some embodiments, this order may be assigned by in an ascending order from lowest SOC, beginning with the PEV 9030 that is removably coupled to a given final male connector 216 and that has the lowest SOC. In some embodiments or applications, a SOC of a given PEV 9030 may be conveyed from the given PEV 9030 via a pilot signal or other similar communication from the given PEV 9030 to controller 220, e.g., utilizing a given power distribution cable 214.

In some embodiments, option 630 may further comprise determining the order by adding a required limitation that the PEV 9030 with the lowest SOC also be ready to accept distribution of the at least some of the electrical power. In some embodiments, option 630 may further comprise determining the order by adding a required limitation that the any PEV 9030 to be charged, also had provided the valid payment selection.

In some embodiments, option 632 may be base order of charging priority on highest SOC detected or highest SOC presented. In some embodiments, the order of power distribution algorithm 626 may comprise determining the order according to an evaluation of SOC for each PEV removably coupled to a given final male connector 216. In some embodiments, this order may be assigned by in a descending order from highest SOC, beginning with the PEV 9030 that may be removably coupled to a given final male connector 216 and that has the highest SOC. PEVs 9030 with higher SOCs than other PEVs 9030 will require less time to charge, so this option may be desirable when desirable to charge PEVs 9030 first that may need less charging time. For example, and without limiting the scope of the present invention, if one PEV 9030 may be presently receiving charging, and two other PEVs 9030 may removably couple to final male connectors 216, where one of those two other PEVs 9030 has a SOC of 90% and the other of those two other PEVs 9030 has a SOC of 55%, the PEV 9030 that has the 90% SOC will be chosen as next up in the charging order once the one PEV 9030 that is presently receiving charges completes that charging (according to PEV distribution algorithm 650).

In some embodiments, option 632 may further comprise determining the order by adding a required limitation that the PEV 9030 with the highest SOC also be ready to accept distribution of the at least some of the electrical power. In some embodiments, option 632 may further comprise determining the order by adding a required limitation that the any PEV 9030 to be charged, also had provided the valid payment selection.

In some embodiments, option 634 may be base order of charging on selected time slots. In some embodiments, the order of power distribution algorithm 626 may comprise determining the order of charging according to receiving a selected time slot for charging the PEV 9030 removably coupled to a given final male connector 216. The selected time slot may be selected from a group comprising at least one available time slot (e.g., from time slots not already selected by another user 9050). Once the selected time slot may be selected, the selected time slot may be removed from the group comprising the at least one available time slot.

In some embodiments, option 634 may further comprise determining the order by adding a required limitation that the PEV 9030 also be ready to accept distribution of the at least some of the electrical power by the time the selected time slot is reached. In some embodiments, option 634 may further comprise determining the order by adding a required limitation that the any PEV 9030 to be charged, also had provided the valid payment selection.

In some embodiments, option 636 may be base order of charging received start and stop times. In some embodiments, the order of power distribution algorithm 626 may comprise determining the order of charging according to receiving a selected start time and a selected stop time for charging the PEV 9030 removably coupled to a given final male connector 216. The selected start time and the selected stop time may be selected from a group comprising at least one available start time and at least one available stop time. Once the selected start time and the selected stop time may be selected, then the selected start time and the selected stop time may be removed from the group comprising the at least one available start time and the at least one available stop time.

In some embodiments, option 636 may further comprise determining the order by adding a required limitation that the PEV 9030 also be ready to accept distribution of the at least some of the electrical power by the time the selected start time is reached. In some embodiments, option 636 may further comprise determining the order by adding a required limitation that the any PEV 9030 to be charged, also had provided the valid payment selection.

In some embodiments, option 638 may be base order of charging priority based on expected departure times. In some embodiments, option 638 may comprise receiving (e.g., at controller 220) a minimum time parked temporal value for each PEV 9030 removably coupled to a given final male connector 216. In some embodiments, in determining this order of charging, option 638 may determine the order based on using an ascending order beginning with a smallest of the minimum time parked temporal values. That is, in such embodiments, the PEV 9030 whose user 9050 indicates that the PEV 9030 may be parked for the shortest time, may receive the highest priority in determining the order of charging.

That is in some embodiments, option 638 may comprise receiving an expected departure temporal value for each PEV 9030 removably coupled to a given final male connector 216. In some embodiments, in determining this order of charging, option 638 may determine the order using an ascending order beginning with the expected departure temporal value that is closest in time to a present time.

In some embodiments, option 638 may further comprise determining the order by adding a required limitation that the any PEV 9030 to be charged, also had provided the valid payment selection.

In some embodiments, option 640 may be base order of charging priority on smallest desired SOC. In some embodiments, option 640 may comprise receiving a desired (e.g., target) SOC value for each PEV 9030 removably coupled to a given final male connector 216. In some embodiments, in determining this order of charging, option 640 may determine the order using an ascending order beginning with the desired SOC value that is smallest. For example, and without limiting the scope of the present invention, if one PEV 9030 may be presently receiving charging, and two other PEVs 9030 may removably couple to final male connectors 216, where one of those two other PEVs 9030 indicates a desired 5% increase in SOC and the other of those two other PEVs 9030 indicates a desired 25% increase in SOC, the PEV 9030 that indicated the desired 5% increase in SOC will be chosen as next up in the charging order once the one PEV 9030 that is presently receiving charges completes that charging (according to PEV distribution algorithm 650).

In some embodiments, option 640 may further comprise determining the order by adding a required limitation that the any PEV 9030 to be charged, also had provided the valid payment selection.

In some embodiments, option 642 may be base order of charging priority on highest desired SOC. In some embodiments, option 642 may comprise receiving a desired SOC value for each PEV 9030 removably coupled to a given final male connector 216. In some embodiments, in determining this order of charging, option 642 may determine the order using a descending order beginning with the desired SOC value that is largest. For example, and without limiting the scope of the present invention, if one PEV 9030 may be presently receiving charging, and two other PEVs 9030 may removably couple to final male connectors 216, where one of those two other PEVs 9030 indicates a desired SOC of 85% and the other of those two other PEVs 9030 indicates a desired SOC of 80%, the PEV 9030 that indicated the desired 85% SOC will be chosen as next up in the charging order once the one PEV 9030 that is presently receiving charges completes that charging (according to PEV distribution algorithm 650).

In some embodiments, option 642 may further comprise determining the order by adding a required limitation that the any PEV 9030 to be charged, also had provided the valid payment selection.

In some embodiments, option 644 may base order of charging priority on smallest desired SOC or expected departure time, whichever occurs first. In some embodiments, option 644 may comprise receiving an expected departure temporal value and receiving a desired SOC value (or incremental increase in SOC) for each PEV 9030 removably coupled to a given final male connector 216. In some embodiments, in determining this order of charging, option 644 may determine the order of charging using a combination of the expected departure temporal values and the desired SOC values to set the order by assigning priority to one or more of: the expected departure temporal values closest in time to a present time or the desired SOC values that are smallest.

In some embodiments, option 644 may further comprise determining the order by adding a required limitation that the any PEV 9030 to be charged, also had provided the valid payment selection.

In some embodiments, option 646, depicted in FIG. 6H, may base order of charging priority on higher amount paid. In some embodiments, user 9050 (e.g., a PEV 9030 driver) may elect to pay more to increase user's 9050 priority in the order of charging. Further in such embodiments, any user 9050 (e.g., other PEV 9030 drivers) whose order may be lowered to a lower priority due to another user 9050 offering to pay more, may be notified prior to accepting the other user's 9050 offer and given an opportunity to out bid that other user 9050. Such notifications may utilize one or more mobile computing devices 9040, network 420, network adapter 226 of controller 220, and/or one or more servers 410. This process may continue on in an iterative manner resulting in an auction that may determine the order for charging.

In some embodiments, option 648 may be charging in a parallel fashion as opposed to serial or sequential charging. That is, in option 648, two or more PEVs 9030 removably coupled to final male connectors 216 may be charged in parallel, that is, simultaneously. Due to incoming power into charging station expander 200 or charging station 300 being finite (e.g., 120 volts, 220 volts, 120/208 volts, 277/480 volts, 120/240 volts, 240/480 volts, and/or the like) charging in parallel may be slower, since that incoming power must be subdivided amongst the PEVs 9030 receiving power. However, such parallel charging may be desirable when expected departure times may be sufficiently long, for example, with PEVs 9030 parked at airports.

In some embodiments, once all PEVs 9030 removably coupled to final male connectors 216 have received charging according the PEV distribution algorithm 650, option 648 may be employed to keep such charged PEVs 9030 charged, i.e. “topped-off” at some predetermined SOC threshold 652. For example, and without limiting the scope of the present invention, in some embodiments, this predetermined SOC threshold 652 may be any number above 75% and including 100%. In such embodiments, the SOCs of each PEV 9030 removably coupled to final male connectors 216 may be periodically checked.

In some embodiments, option 648 may further comprise determining the order by adding a required limitation that the any PEV 9030 to be charged, also had provided the valid payment selection.

FIG. 6I may depict a flow diagram depicting further detailed steps for how the electrical power may be distributed to the PEVs 9030 that may be removably coupled to final male connectors 216. FIG. 6I may depict further details of step 608. In some embodiments, distribution of the at least some of the electrical power to the PEV 9030 presently receiving the at least some of the electrical power may continue receiving such electrical power according to PEV distribution algorithm 650. In some embodiments, once the PEV distribution algorithm 650 may determine distribution has completed of the PEV 9030 presently receiving the at least some of the electrical power, then distribution switches to a next PEV 9030 per the order of charging per the option in use under the order of power distribution algorithm 626. And then that PEV 9030 to be charged may be charged according to the PEV distribution algorithm 650.

In some embodiments, the PEV distribution algorithm 650 may distribute the at least some of the electrical power to a given PEV 9030 until one or more of the following may be reached: a predetermined SOC threshold 652, a selected stop time 654, conclusion of a selected time slot 658, a received departure time is reached 656, or prepayment no longer covers continued distribution 660 (i.e. payment may be exhausted 660).

In some embodiments, the PEV distribution algorithm 650 may require confirmation of the valid payment selection before permitting distribution of the at least some of the electrical power.

In some embodiments, if distribution (of electrical power) ceases prior to a monetary value associated with the valid payment selection being exhausted, then the method may cause a refund transaction to initiate. Such a refund may be distributed as cash (including coins) via integral input device 250. Credit card charge backs may be processed electronically on a back end, initiated by controller 220 in communication with one or more servers 410 or one or more mobile computing devices 9040.

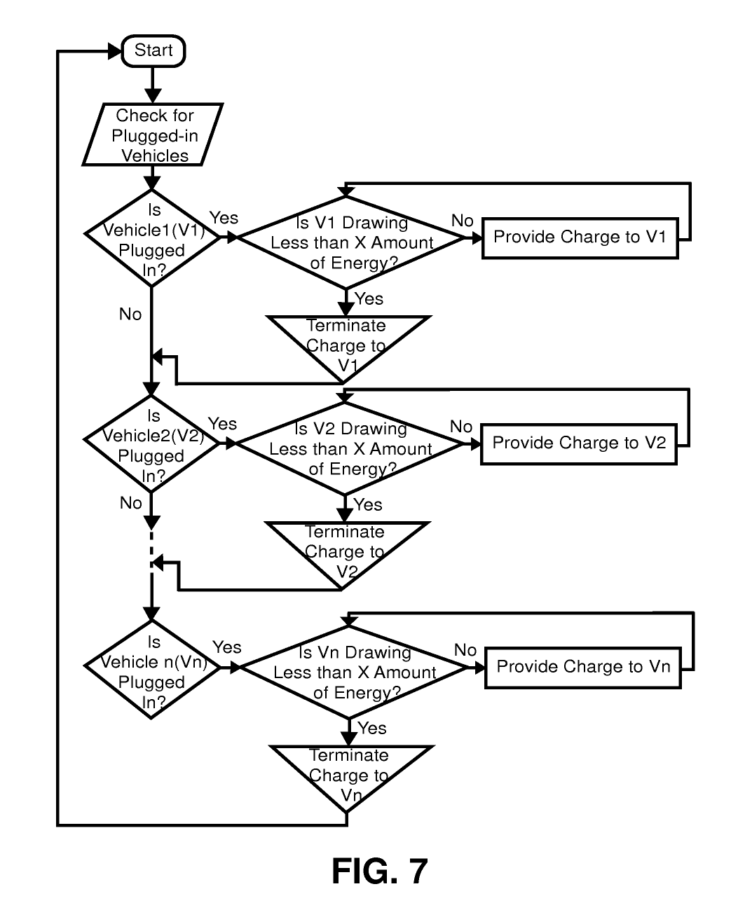

FIG. 7 may depict an embodiment of PEV distribution algorithm 650. In particular, FIG. 7 may depict an embodiment of utilizing predetermined SOC reached 652. FIG. 7 may be a logic flow diagram for when two or more PEVs 9030 (e.g., PEV1 9030 and PEV2 9030) that may be removably connected to charging station expander 200 or charging station 300; and how PEV1 9030 may be charged to predetermined SOC reached 652 before terminating electrical power transmission to PEV1 9030 and then switching to charge PEV2 9030; where charging of PEV2 9030 may also proceeds to predetermined SOC reached 652. In FIG. 7, PEV1 9030 may be designated Vehicle1 (V1). In FIG. 7, PEV2 9030 may be designated Vehicle2 (V2). In FIG. 7, predetermined SOC reached 652 may be designated X. For example, and without limiting the scope of the present invention, in some embodiments, this predetermined SOC threshold 652, i.e. X, may be any number above 75% and including 100%. Determination of what PEV 9030 may be PEV2 9030, i.e. the PEV 9030 next up in the queue, may occur by order of power distribution algorithm 626.

As noted above, any given PEV 9030, that may be removably coupled to final male connectors 216, may have its SOC reported to controller 220 and/or reported to one or more servers 410. (Any PEV 9030 may store (non-transitorily) and periodically updates its SOC in its repository.) Such reporting may be accomplished by one or more of: signals being sent through a given power distribution cable 214; and/or signals being sent wirelessly (directly or via network 420). Wherein, within such signals is the SOC information for a given PEV 9030 that may be removably coupled to final male connectors 216. Such reporting may be automated and may be a standard step part of a communication/power transmission standard between final male connectors 216 and port 9032, e.g., an applicable SAE standard.

In some embodiments, user 9050 may manually enter and convey the SOC information to controller 220 and/or reported to one or more servers 410, e.g., by using one or more mobile computing devices 9040 and/or integral input device 250.

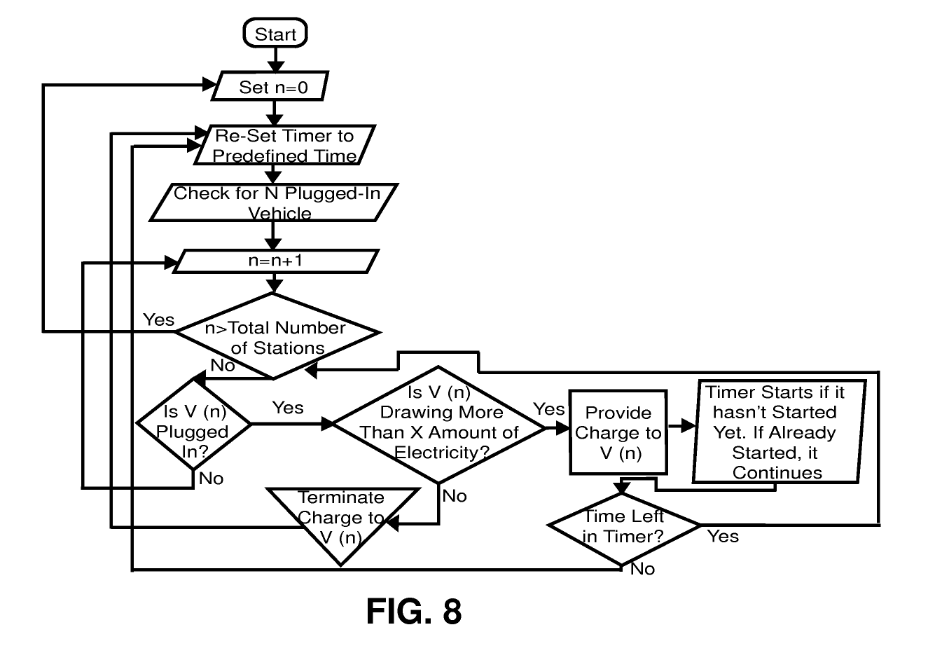

FIG. 8 may depict an embodiment of PEV distribution algorithm 650. In particular, FIG. 8 may depict an embodiment of utilizing selected stop time reached 654. FIG. 8 may be a logic flow diagram for when two or more PEVs 9030 (e.g., PEV1 9030 and PEV2 9030) that may be removably connected to charging station expander 200 or charging station 300; and how PEV1 9030 may be charged to selected stop time reached 654 before terminating electrical power transmission to PEV1 9030 and then switching to charge PEV2 9030; where charging of PEV2 9030 may also proceed to selected stop time reached 654 (which may of course be different from selected stop time reached 654 associated with PEV1 9030). In some embodiments, selected stop time reached 654 may be points in time in a 24 hour period. In some embodiments, selected stop time reached 654 may be points in time in a 24 hour period and designation of a particular day (e.g., a date). In some embodiments, instead of using points in time (and dates), selected stop time reached 654 may be predefined amounts of charging time. For example, and without limiting the scope of the present invention, selected stop time reached 654 may be about 4 hours (plus or minus one minute). In other embodiments, other durations may be predetermined.

In some embodiments of FIG. 8, in addition to each PEV 9030 being charged for or until selected stop time reached 654 may be reached, before initiating a timer to count to selected stop time reached 654, the method may determine if the present PEV 9030 receiving electrical power transmission, e.g., PEV1 9030, may be drawing more than an amount X of electricity; and if yes, then the method starts the timer; and if no, then charging terminates for PEV1 9030 and switches to PEV2 9030.

In FIG. 8, PEV1 9030 may be designated by V(n), where n is 1. In FIG. 8, PEV2 9030 may be designated by V(n), where n is 2. In FIG. 8, N may a total number (quantity) of PEVs 9030 removably coupled to final male connectors 216. Determination of what PEV 9030 may be PEV2 9030, i.e. the PEV 9030 next up in the queue, may occur by order of power distribution algorithm 626.

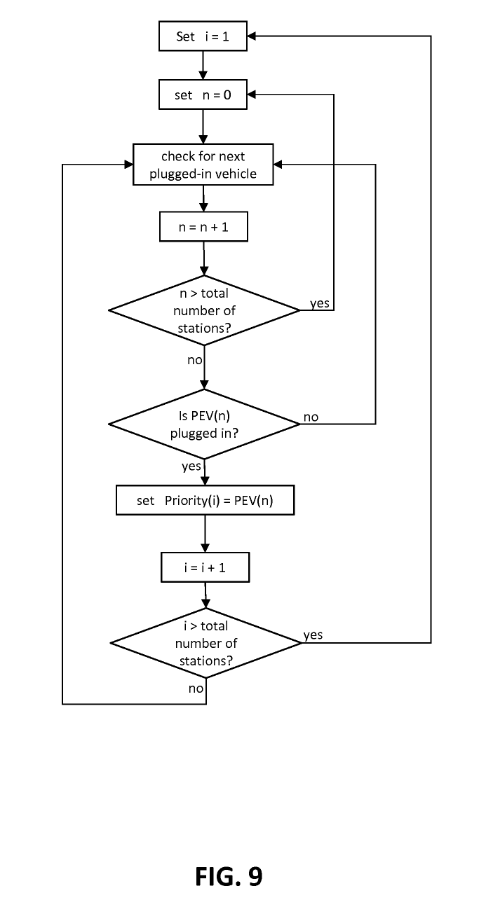

FIG. 9 may depict a logic flow diagram showing an embodiment of order of power distribution algorithm 626. In particular, FIG. 9, may depict a logic flow diagram showing an embodiment of determining priority by first in time to connect 628.

In some embodiments, systems and/or methods, may continuously or may periodically look (scan) for a next PEV 9030 that may get removably coupled to a given final male connector 216. In some embodiments, such scanning may occur in a serial fashion, where each final male connector 216 may be scanned for removably coupling with a give port 9032. In some embodiments, as an alternative to scanning, the systems and/or the methods may detect when the next PEV 9030 may get removably coupled to the given final male connector 216. For example, and without limiting the scope of the present invention, such detection may occur by receiving pilot signals or other communication signals from the next PEV 9030. In FIG. 9, n may be a total number of final male connectors 216. In FIG. 9, V(n) may be a total number of PEVs 9030 that may be removably coupled to final male connectors 216. Under priority by first in time to connect 628, the next PEV 9030 that removably couples to an available final male connector 216 may be assigned the next open queue.

In FIG. 9, in some embodiments, the order of charging the PEVs 9030 may occur in an ascending order, i.e., PEV1, PEV2, . . . , PEV(n); wherein PEV1 may have been removably coupled before PEV2, and PEV2 may have been removably coupled before PEV(n), and so on. The next assigned charging position in this queue after PEV(n) is PEV1, and this cycle may to cycle in this fashion.

In some embodiments, a common entity may control both one or more power sources 9020 (or existing charging station 9010) and one or more charging stations 300 or one or more charging station expanders 200, and may then have a need to determine optimal charging of one or more PEVs 9030 removably coupled to a given final male connector 216.

For example, and without limiting the scope of the present invention, the common entity may be selected from one or more of: individual residence owners, individual businesses, independent (or third party) source providers of electrical power (such as utility companies), and/or the like. For example, the common entity may be a single family home owner who may utilize solar power (which may be power source 9020) to produce electrical power that may then be stored in a battery (or batteries) and who may also have one or more PEVs 9030 and either at least one charging station 300 or at least one charging station expander 200 and an existing charging station 9010. That home owner may or may not be entirely independent from the independent (or third party) source providers of electrical power (such as utility companies).

In some embodiments, that optimal charging may mean charging the one or more PEVs 9030 in a manner that minimizes demand upon the one or more power sources 9020, or upon an intermediary device such as the battery or batteries. In some embodiments, that optimal charging may mean charging the one or more PEVs 9030 in a manner that is least likely to interfere with PEV 9030 user's schedule, such as a need to commute to work. Or in some embodiments, both minimizing demand upon the one or more power sources 9020 or upon the intermediary device such as the battery or batteries and minimizing interference with PEV 9030 user's schedule may be taken into account in determining optimal charging times (schedules).

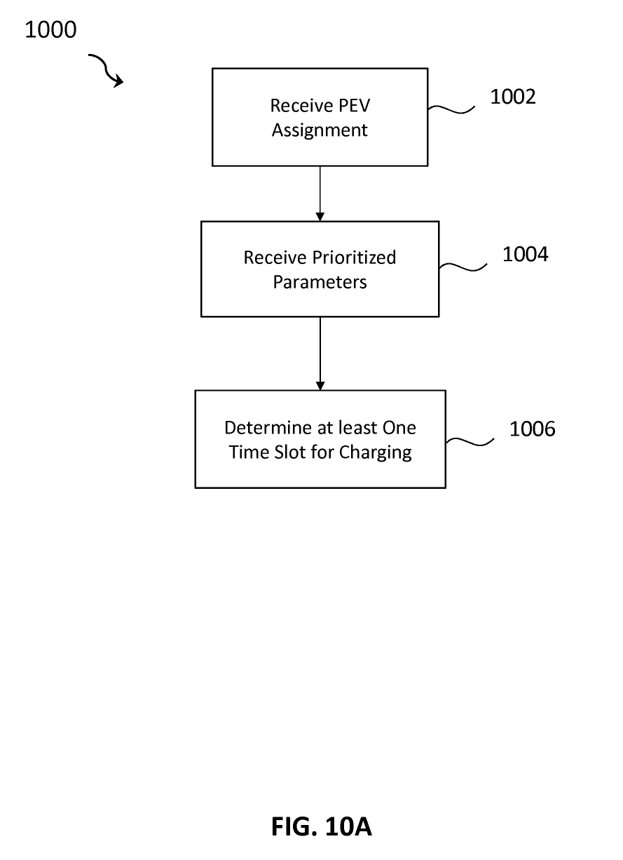

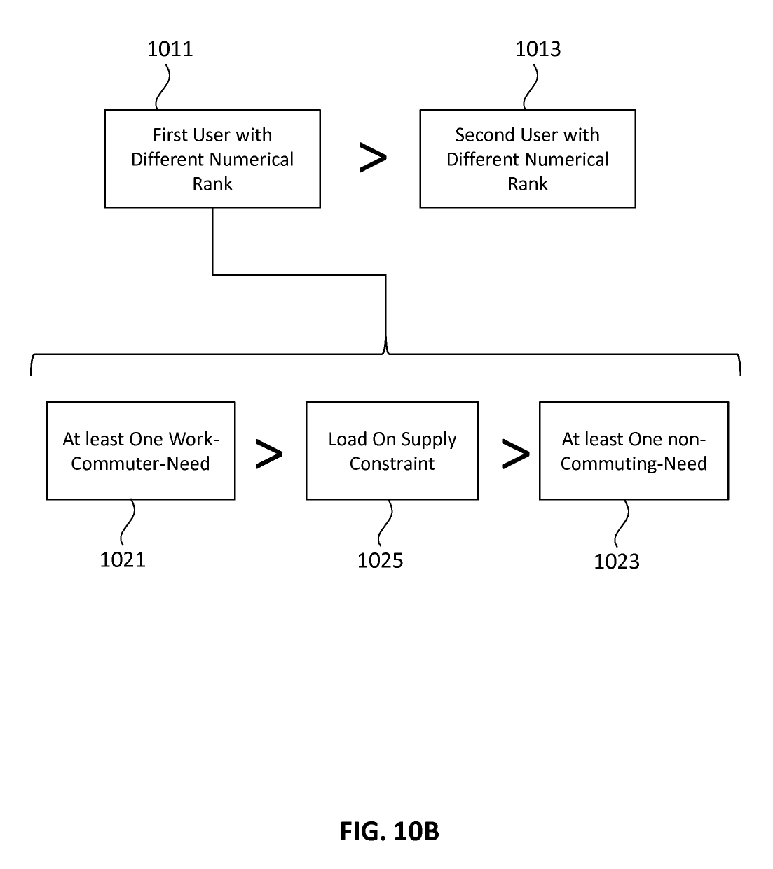

FIG. 10A may depict a method 1000 for determining at least one optimal charging schedule for one or more PEVs 9030. FIG. 10B may depict some priority relationships between PEV assignments and some priority relationships between prioritized parameters.

In some embodiments, method 1000 for determining at least one optimal charging schedule for one or more PEVs 9030 may comprise the steps of: receiving a plug-in vehicle (PEV) assignment 1002 for each user of the one or more PEVs 9030; wherein each PEV assignment may have a different numerical rank; receiving prioritized parameters 1004 per each user of a PEV 9030 selected from one or more PEVs 9030; wherein each prioritized parameter selected from the prioritized parameters may have a numerical different priority; and step 1006 for determining the at least one optimal charging schedule for each PEV 9030 selected from the one or more PEVs 9030 by scheduling charging during at least one time slot that may be compliant with a highest of the numerical different priority of the prioritized parameters for a given user with a highest of the different numeral rank. In some embodiments, this step 1006 of determining this at least one time slot may also require that the at least one time slot be compliant with a greatest number of next highest prioritized parameters, in descending order. That is, in some embodiments, determination of this at least one time slot may seek a time slot that is compliant with the greatest number of prioritized parameters, but that must always satisfy a highest of the prioritized parameters for a given user.

That is, in some embodiments, step 1006 in FIG. 10A must at least determine the at least one time slot that is compliant with the highest of the prioritized parameters for a given user. In some embodiments, this highest of the prioritized parameters may be at least one work-commuter-need 1021; and in other embodiments, this highest of the prioritized parameters may be determinable by the user. Then that determined time slot may be shifted if possible to accommodate next highest prioritized parameters, which may be one of the load on supply constraints 1025, until a final time slot may be achieved that is compliant with the greatest number of prioritized parameters.

In some embodiments, each PEV assignment may result in a numeral rank. When there may be more than one PEV assignment, then the numeral ranks may be different, designated as different numeral ranks. In some embodiments, differences in the different numerical ranks of PEV assignments may be used to resolve conflicts as between users, e.g., two users and two PEVs who may want charging at the same time from a single device, such as charging station expander 200 or charging station 300. A user with a higher different numeral rank over a user with a lower different numeral rank may have priority in terms of scheduling of charging. In some embodiments, difference in the prioritized parameters may be used to resolve conflicts with respect to the same user. For example, with respect to the same user, there may be conflict in scheduling charging as between a user's personal needs to travel to some destination (e.g., work) versus needs to schedule charging during minimal load times, off-peak times, at nighttime, and/or during cooler weather.

In some embodiments, the PEV assignment for each user may be established on a basis of a number of PEVs 9030 and on a number of users. For example, and without limiting the scope of the present invention, if there is more than one PEV 9030 and if there is more than one user, then at least a first PEV may be assigned to a first user and a second PEV may be assigned to a second user, and so on. In some embodiments, the first user's different numerical rank 1011 may be higher than the second user's different numerical rank 1013. See e.g., FIG. 10B. In some embodiments, these two users may determine amongst themselves which may be designated as the first user and which the second user.

With respect to PEV assignments, for example, and without limiting the scope of the present invention, if there is one PEV 9030 and if there is the more than one user, then the one PEV 9030 may be assigned to each of the more than one user but with different time slots for each user. In this scenario, each different time slot may be assigned a different numeral rank, in order to prioritize between the different time slots. In some embodiments, these different time slots may be selected from one or more of: different days of the week, day of the week with different times, daily with different times, different weeks, different months, and/or the like. For example, and without limiting the scope of the present invention, a single PEV 9030 being shared between two users, might be assigned to the first user Monday morning through Friday evening, and assigned to the second user on the weekends. For example, and without limiting the scope of the present invention, a single PEV 9030 being shared between two users, might be assigned to the first user Monday through Friday from 7 am through 7 pm and to the second user at the remaining times.

With respect to PEV assignments, for example, and without limiting the scope of the present invention, if there is the one PEV 9030 and if there is one user, then the one PEV 9030 may be assigned to the one user. In such scenarios there then may only be one numerical rank.

With respect to PEV assignments, for example, and without limiting the scope of the present invention, if there is the more than one PEV 9030 and if there is the one user, then the more than one PEV 9030 may be assigned to the one user.

In some embodiments, the prioritized parameters may comprise one or more of: user needs or load on supply constraints 1025. For example, and without limiting the scope of the present invention, the user needs may address the user's own scheduling needs around the user's own schedule, such as a need to get to work and back. In some embodiments, the user needs may comprise one or more of: at least one work-commuter-need 1021 or at least one non-commuting-need 1023. In some embodiments, at least one work-commuter-need 1021 may be associated with a user's needs to have at least one PEV 9030 selected from one or more PEVs 9030 available and sufficiently charged to enable that user to commute to work and/or back to home. In some embodiments, at least one non-commuting-need 1023 may designate at least days and/or times when a user's need for at least one PEV 9030 selected from one or more PEVs 9030 may be for non-work needs, such as leisure activities, and/or errands. In some embodiments, at least one work-commuter need 1021 may have a higher priority than at least one non-commuting-need 1023. See e.g., FIG. 10B. In some embodiments, such a default setting of priorities between at least one work-commuter-need 1021 and at least one non-commuting-need 1023 may be modified.

In some embodiments, at least one work-commuter-need 1021 may comprise days with times when at least one PEV 9030 selected from one or more PEVs 9030 should be charged by. For example, and without limiting the scope of the present invention, in some embodiments, these days with times may be a time each work day morning where at least one PEV 9030 selected from the one or more PEVs 9030 should be charged by, so that the given user may be able to use that at least one PEV 9030 for commuting to work. For example, and without limiting the scope of the present invention, this may be Monday through Friday at 7 am. Other days and/or times may be selected by the user. For example, and without limiting the scope of the present invention, in some embodiments, these days with times may be a time each work day evening where the at least one PEV 9030 selected from one or more PEVs 9030 should be charged by, so that the given user may be able to use that at least one PEV 9030 for commuting from work to home. For example, and without limiting the scope of the present invention, this may be Monday through Friday at 7 pm. Other days and/or times may be selected by the user.

In some embodiments, at least one work-commuter-need 1021 may comprise a length of commute (e.g., in miles or kilometers). In some embodiments, method 1000 may receive the length of commute for each of at least one work-commuter-need 1021 for each user. In some embodiments, it may be recommended to the user to include some additional miles or kilometers over an actual length of commute for the length of commute to act as a buffer. Such a buffer may be used to account for unexpected traffic delays and/or to run errands. In some embodiments, the length of commute, including plus the buffer, may be set and/or determined by each user. In some embodiments, a determination of a start time of the at least one time slot (that may be the at least one optimal charging schedule) may be proportional to the length of commute. In some embodiments, a longer the length of commute a farther the start time may be from a day and time designated that at least one PEV 9030 selected from one or more PEVs 9030 should be charged by. In some embodiments, the length of the commute received may be for one-way between home and work or may be round-trip in some embodiments. In some embodiments, the at least one work-commuter need 1021 with a longer length of commute may have a higher priority than another at least one work-commuter need 1021 with a shorter length of commute. In some embodiments, at least one work-commuter-need 1021 may comprise a length of commute (e.g., in miles or kilometers); and at least one work-commuter-need 1021 may also comprise days with times when at least one PEV 9030 selected from one or more PEVs 9030 should be charged by.

With respect to another category of prioritized parameters, determining load on supply constraints 1025 may be for determining loads on power source 9020 and/or on independent power source(s); or for determining approximate loads or approximate off-peak hours. Determining such loads may be important for attempting to schedule charging of at least one PEV 9030 selected from one or more PEVs 9030 when there may be minimal loads, e.g., in scenarios where the homeowner (or business owner) may be generating at least some of their own electrical power. Determining such loads may be important for attempting to schedule charging of at least one PEV 9030 selected from the one or more PEVs 9030 during off-peak hours, e.g., in scenarios where the provider of charging station expander 200 and/or charging station 300 (e.g., a homeowner, a business, a parking facility, and the like) must pay a separate utility entity for electrical power consumed by charging station expander 200 and/or charging station 300. This separate utility entity may be the independent (or third party) source providers of electrical power (such as utility companies).

In some embodiments, load on supply constraints 1025 may comprise one or more of: at least one load measurement of a power source (e.g., power source 9020), at least one received notice of off-peak time, determination of a present time, and/or at least one receive notice of weather local to the power source. Taking periodic load measurements of the power source (e.g., power source 9020) may require one or more load sensing devices in communication with a circuit of the power source. Such load sensing devices may be multimeter type devices and/or the like. The one or more load sensing devices may also be in communication with one or more servers 410 and/or controller 220.

Off-peak time(s) may be published from the utility provider of electrical power from power source 9020 (or an agent thereof). (This utility provider may be the independent (or third party) source providers of electrical power [such as utility companies].) Off-peak time(s) may correspond to times of the day when the utility provider charges less money for customers consuming the electrical power provided by that utility provider. Off-peak times may vary by one or more of: different utility providers, time of the day, seasonally, time of the year, regionally, geographically, and/or by the nature of the power source 9020. For example, and without limiting the scope of the present invention, many off-peak times often occur a night. For example, and without limiting the scope of the present invention, publications of off-peak times may be by website and/or other data feeds (which may be subscription based). Such publications of off-peak times may be received by the system and/or the method (e.g., method 1000) and utilized in determining the at least one optimal charging schedule for one or more PEVs. To aid in this, the system and/or method 1000 may also track present time. This may be accomplished by an integral clock (integral with a component of the system, e.g., at least one server 410 and/or controller 220) and/or by receiving time information from any number of different data feed sources that provide time information. Determining present time may also facilitate determining when it may be nighttime, which may be designated as a default off-peak time. In some embodiments, monitoring or determining, or receiving local weather information (such as temperature), that is local to power source 9020, may also be used to approximate off-peak times, since hot weather may be associated with peak times and cooler weather associated with off-peaks times. In some embodiments, local may be a weather measurement within 20 miles of power source 9020. Such local weather may be monitored or determined, or received by use of integral thermometers and/or by receiving appropriate data feed(s) that may convey local weather information. Integral with a component of the system, e.g., at least one server 410 and/or controller 220.

In some embodiments, a load measurement that may indicate a lower load may have a higher priority over a load measurement that may indicate a higher load. In some embodiments, off-peak times may have a higher priority over peak times. In some embodiments, nighttime may have a higher priority over daytime. In some embodiments, cooler local weather may have a higher priority over hotter local weather.

Ideally, scheduling of the at least one time slot (that may be the at least one optimal charging schedule) may coincide when at least one work-commuter-need 1021 may be designated with days and times that permit the scheduling during minimal loads on power source 9020, during off-peak hours, during the nighttime, and/or during cooler weather. However, in the event of conflict between these prioritized parameters the days and times of the at least one work-commuter-need 1021 may trump (take priority) over times of minimal load on power source 9020, off-peak time, nighttime, and/or cooler weather. That is in some embodiments, at least one work-commuter-need 1021 may trump load on supply constraints 1025. For example, a user may have a work schedule that necessitates charging of at least one PEV 9030 selected from one or more PEVs 9030 during higher load times on power source 9020, during peak times, during the day, and/or during hotter weather. That is, in some embodiments, step 1006 in FIG. 10A must at least determine the at least one time slot that is compliant with a highest of the prioritized parameters for a given user. In some embodiments, this highest of the prioritized parameters may be at least one work-commuter-need 1021; and in other embodiments, this highest of the prioritized parameters may be determinable by the user. Then that time slot may be shift if possible to accommodate next highest prioritized parameters, which may be one of the load on supply constraints 1025.

Such methods (e.g., method 1000) may be implemented using (via): one or more servers 410, controller 220, one or more mobile devices 9040, one or more PEVs 9030, and/or the like.

In some embodiments, one or more power sources 9020 may refer to an access point or connection point with a source of electrical power, such as the grid providing electrical power from a utility entity or other source provider of electrical power. Generally, such source providers of electrical power charge via some mechanism for consumption of electrical power provided by the source provider. Source providers may also be from individual residences and/or individual businesses that may be producing their own electrical power from various means, such as, but not limited to, solar, wind, geothermal, gas, coal, hydroelectric, wave, tidal, fuel cell, battery, and combinations thereof.

In some embodiments, one or more of the methods and/or one or more of the steps described and disclosed above may be implemented as computer program(s), software, firmware, including codes executable by a processor (e.g., processor 224 of controller 220, processors associated with one or more servers 410, and/or processors associated with one or more mobile computing devices 9040). Such computer program(s), software, firmware, and/or code may be non-transitorily stored in computer-readable media, such as memory 222, memory of one or more servers 410, and/or memory of one or more mobile computing devices 9040.

Various aspects of the systems and methods for practicing features of the present invention may be implemented on one or more computer systems. See e.g., FIG. 2B and FIG. 2C with respect to controller 220 and see FIG. 4A, FIG. 4B, FIG. 5A, and FIG. 5B; as well as the discussion of those figures above. For example, the various controller 220 components, such as but not limited to, processor 224, memory 222, network adapter 226, integral display 236, integral input device 250, safety problem detector 252 may all be coupled, directly or indirectly, via interconnection mechanisms, which may comprise one or more buses, switches, networks, cloud, and/or any other suitable interconnection. Integral input device 250 and/or one or more mobile computing devices 9040 may receive input from user 9050. Integral display 236 and/or one or more mobile computing devices 9040 may display or and/or controller 220 (via network adapter 226) may transmit information to user 9050 or to one or more mobile computing devices 9040 or to one or more servers 410. Such input and output means (e.g., integral display 236 and integral input device 250) may be used, among other things, to present a user interface, such as a graphical user interface (GUI). Examples of output units that can be used to provide a user interface may comprise printers or display screens for visual presentation of output and speakers or other sound generating devices for audible presentation of output. Examples of input units that can be used for a user interface may comprise keyboards, and pointing devices, such as mice, touch pads, and digitizing tablets. As another example, a computer may receive input information through speech recognition or in other audible format.

Processors (e.g., processor 224 of controller 220, processors associated with one or more servers 410, and/or processors associated with one or more mobile computing devices 9040) may also execute one or more computer programs, such as software, firmware, and/or code to implement various methods and steps. These computer programs may be written in any type of computer program language, including a procedural programming language, object-oriented programming language, macro language, or combination thereof.

These computer programs may be non-transitorily stored in computer-readable media, such as memory 222, memory of one or more servers 410, and/or memory of one or more mobile computing devices 9040. Such non-transitorily storage in computer-readable media may be in volatile or non-volatile medium, and may be fixed or removable. Such computer-readable media may include a tangible computer readable and computer writable non-volatile recording medium, on which signals are stored non-transitorily that define a computer program or information to be used by the program. The recording medium for the computer-readable media may, for example, be disk memory, flash memory, and/or any other article(s) of manufacture usable to record and store information. Typically, in operation, the processors may cause data to be read from the nonvolatile recording medium into a volatile memory (e.g., a random access memory, or RAM) that allows for faster access to the data and/or information by the processers than from the nonvolatile recording medium. The processors may generally manipulate the data and/or information within the RAM memory and then copy the manipulated data and/or information to the nonvolatile recording medium after processing is completed. A variety of mechanisms are known for managing data movement between the medium and the integrated circuit memory element, and the invention is not limited to any mechanism, whether now known or later developed. Various embodiments of the invention are also not limited to a particular processor nor to particular computer readable media (whether volatile or non-volatile).

A charging station expander and a charging station have been described, as well as systems and methods for charging two or more plug-in electric vehicles utilizing the one or more of the charging station expander or the charging station. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A charging station expander for receiving electrical power from an existing charging station and distributing the electrical power received to at least one plug-in electrical vehicle selected from two or more plug-in electrical vehicles, wherein the charging station expander comprises:
a female port for receiving a male connector; wherein the male connector is connected via a cable to the existing charging station; wherein the female port receives the electrical power from the male connector;
a switch relay comprising two or more switches; wherein the switch relay is in electrical communication with the female port such that at least some of the electrical power from the female port is received at the switch relay; wherein each switch selected from the two or more switches has two operational states: engaged and non-engaged; wherein in the engaged operational state the switch allows electrical flow; wherein in the non-engaged operational state the switch does not allow electrical flow;
two or more power distribution cables; wherein each power distribution cable selected from the two or more power distribution cables originates from each switch selected from the two or more switches; wherein each power distribution cable selected from the two or more power distribution cables terminates in a final male connector; wherein each final male connector removably connects to a port of each plug-in electrical vehicle selected from the two or more plug-in electrical vehicles; wherein each power distribution cable receives at least a portion of the at least some of the electrical power from the switch in which the power distribution cable is connected to is engaged;
a controller; wherein the controller is in electrical communication with the switch relay; wherein the controller comprises memory and a processor; wherein the memory and the processor are in electrical communication with each other; wherein the memory non-transitorily stores software, wherein the processor executes the software to control the switch relay by at least engaging and disengaging switches selected from the two or more switches;
a housing; wherein the housing houses the switch relay and the controller; wherein the female port is located on an exterior of the housing or wherein the female port is accessible from the exterior; wherein at least some portion the two or more distribution cables emerge from the housing;
wherein the charging station expander is disposed between the existing charging station and the two or more plug-in electrical vehicles.

2. The charging station expander according to claim 1, wherein the female port is configured according to SAE J1772 standard to be removably coupled with the male connector that is also configured according to the SAE J1772 standard; wherein the female port comprises five receptacles, with two of the five receptacles configured to receive electrical power, a third of the five receptacles connected to ground, a fourth of the five receptacles for communicating pilot signals, and a final receptacle to be paired with a proximity detector of the male connector.

3. The charging station expander according to claim 1, wherein the female port is configured according to one of the following standards: SAE J1772, SAE J2836/1-6, SAE J2847/1-5, or a standard permitting communication that a device is ready to receive the electrical power; and the male connector is also configured to a corresponding complimentary standard to removably couple with the female port.

4. The charging station expander according to claim 1, wherein the female port comprises a tamper resistant device; wherein the tamper resistance device mitigates against uncoupling of the male connector from the female port; wherein the tamper resistance device substantially encloses a portion of an exterior body of the male connector.

5. The charging station expander according to claim 1, wherein the two or more switches are arranged in a parallel configuration.

6. The charging station expander according to claim 1, wherein the two or more switches comprises a number of switches; wherein the number comprises two, three, four, five, six, or seven switches; wherein the two or more distribution cables comprises a quantity of distribution cables that corresponds to the number of the two or more switches.

7. The charging station expander according to claim 1, wherein each distribution cable selected from the two or more distribution cables comprises wiring for electrical power transfer and separate wiring for communications between the controller and the plug-in electrical vehicle selected from the two or more plug-in electrical vehicles that each final male connector is removably connected to.

8. The charging station expander according to claim 1, wherein each final male connector is configured according to SAE J1772 standard to be coupled with the port of each plug-in electrical vehicle selected from the two or more plug-in electrical vehicles; wherein each final male connector comprises five pins, with two of the five pins configured to distribute at least a portion of the at least some of the electrical power, a third of the five pins connected to ground, a fourth of the five pins for communicating pilot signals, and a final pin, a fifth, with a proximity sensor.

9. The charging station expander according to claim 1, wherein each final male connector is configured according to one of the following standards: SAE J1772, SAE J2836/1-6, SAE J2847/1-5, or a standard permitting communication of one or more of a state of charge of the plug-in electrical vehicle connected to the final male connector, a vehicle identification of the plug-in electrical vehicle connected to the final male connector, or a user-account associated with the plug-in electrical vehicle connected to the final male connector.

10. The charging station expander according to claim 1, wherein the controller receives power from one or more of: the female port, the switch relay, or an independent power source that is independent of the existing charging station; wherein the power received by controller is used to operate the controller and the switch relay and to facilitate communications between one or more of: between the controller and the existing charging station, between the controller and the switch relay, or between the controller and the two or more plug-in electric vehicles removably coupled any of the final male connectors.

11. The charging station expander according to claim 1, wherein the controller sends a communication pilot signal to the female port; wherein the female port communicates the communication pilot signal to the male connector; wherein the communication pilot signal mimics a pilot signal from a plug-in electrical vehicle with a status of connected and ready to receive electrical power such that the existing charging station distributes the electrical power.

12. The charging station expander according to claim 1, wherein the controller comprises one or more of the following: a network adapter, a modem, or a router; wherein the one or more of the network adapter, the modem, or the router are in electrical communication with the processor; wherein the one or more of the network adapter, the modem, or the router operate as a gateway to facilitate communication with one or more of the following: one or more mobile computing devices or more or more remote servers.

13. The charging station expander according to claim 12, wherein the one or more of the network adapter, the modem, or the router provide wireless communication via a wireless protocol utilizing at least one radio or at least one antenna.

14. The charging station expander according to claim 1, wherein the controller comprises an integral display; wherein the integral display is located on a portion of the exterior of the housing; wherein the integral display is in electrical communication with the processor; wherein the integral display displays display outputs directed from the processor to the integral display.

15. The charging station expander according to claim 14, wherein the display outputs depict one or more of the following a status of the charging station expander or a status of each plug-in electrical vehicle connected to the charging station expander.

16. The charging station expander according to claim 14, wherein the integral display comprises one or more of the following: at least one light, a screen, a touch screen, a speaker, a siren, or a buzzer.

17. The charging station expander according to claim 1, wherein controller comprises an integral input device; wherein the integral input device is located on a portion of the exterior of the housing; wherein the integral input device is in electrical communication with the processor; wherein the integral input device receives user inputs and directs those user inputs to the processor.

18. The charging station expander according to claim 17, wherein the integral input device comprises one or more of the following: a microphone, at least one button, at least one switch, at least one lever, at least one dial, at least one slide, a touch screen, a keyboard, a joystick, a mouse, or a payment receiving device.

19. The charging station expander according to claim 18, wherein the payment receiving device is selected from one or more of the following: a credit card reader, a means for accepting coins, a means for accepting currency bills, a means for returning change, or at least one radio configured for facilitating payment via a mobile payment system.

20. The charging station expander according to claim 1, wherein the controller comprises a safety problem detector; wherein the safety problem detector is in electrical communication with the processor; wherein when the safety problem detector detects a safety problem, transmission of electrical power to two or more plug-in electrical vehicles is terminated.

21. The charging station expander according to claim 20, wherein the safety problem detector comprises one or more of: an accelerometer, a gyroscopic sensor, an inertial measurement sensor, a hygrometer, or a moisture sensor; wherein the accelerometer, the gyroscopic sensor, and the inertial measurement sensor each detect motion of the charging station expander; wherein when the motion is greater than a predetermined threshold of acceptable motion, the safety problem detector will treat the motion as the safety problem; wherein the hygrometer and moisture sensor each detect moisture, wherein when the moisture is greater than a predetermined threshold of acceptable moisture, the safety problem detector will treat the moisture as the safety problem.

22. The charging station expander according to claim 1, wherein at least some of an exterior of the housing comprises one or more mounting structures, wherein the one or more mounting structures permit attaching the charging station expander to one or more of: the existing charging station, a wall, a girder, a frame, a stud or a substrate.

23. The charging station expander according to claim 1, wherein the housing comprises safety structure to mitigate against impacts to the charging station expander causing damage to the charging station expander.

24. The charging station expander according to claim 23, wherein the safety structure comprises a cage substantially circumscribing the exterior of the housing.

25. The charging station expander according to claim ?, wherein at least a portion of the exterior of the housing comprises a region for displaying one or more of a graphic, a brand, or a trademark.
